(19) United States
(12) Patent Application Publication
(10) Pub. No.: US 2017/0109711 A1
(43) Pub. Date: Apr. 20, 2017

(54) INTERACTION AND RESOURCE NETWORK DATA MANAGEMENT PLATFORM

(71) Applicant: SageLife Innovations, LLC, Horsham, PA (US)

(72) Inventors: Glenna M. Crooks, Horsham, PA (US); Robert Martinson, Spokane, WA (US)

(21) Appl. No.: 15/311,219

(22) PCT Filed: May 15, 2015
(86) PCT No.: PCT/US15/31087

§ 371 Date: Nov. 15, 2016

Related U.S. Application Data
(63) Continuation of application No. 14/278,826, filed on May 15, 2014, now abandoned.
(60) Provisional application No. 62/063,142, filed on Oct. 13, 2014.

(51) Int. Cl. G06Q 10/10; G06Q 50/00

(52) U.S. Cl. CPC G06Q 10/1095; G06Q 50/01

(57) ABSTRACT

The present application discloses systems and methods for generating a personal network resource map of a user based on data that has been inputted by the user regarding his or her relationships. The relationships may be categorized and displayed according to their type, e.g., family, professional, medical/healthcare, spiritual, or educational.

### BACKGROUND OF THE INVENTION

Current time management and productivity improvement methods focus on tasks by promoting listing and prioritizing activities. Those approaches ignore that associated with every task is a person and that the people involved—be they episodic encounters or ongoing/continuing interactions (e.g., personal/business/pet relationships, connections, friendships, family, and others resources like physicians, contractors or a child's teacher, etc.) will—in large part—determine the outcome of the activity. The people involved can be important assets or may create serious liabilities. Pundits postulate that positive ways of relating with others—whether episodically or on an ongoing/continuing basis—are the key to success in business and success and satisfaction in personal life. The “bandwidth” to handle and manage ongoing/continuing interactions is not boundless, however.

Evolutionary psychologists postulate that an individual can successfully manage one-hundred fifty (150) ongoing different interactions at a given time in a person's life. A healthy, energetic, well-organized person armed with the latest in scheduling and communication tools, technologies, and services (e.g., personal digital assistant, smartphone, tablet, email, texting, social media, etc.) can likely manage more interactions than the average but, the number is not unlimited. Few people take account of the number of people they manage. Single homeowners typically manage between forty five and fifty (45-50) relationships in support of basic life-and-home maintenance needs. Adding a spouse/partner, children, pets, elderly parents who need support or an individual's own illness, and this same individual may only have fifty (50) slots left over for ongoing/continuing interactions at work. Further, no robust tools are available to help people gain insight into how to identify, assess and proactively manage relationship networks. Today's 24/7/365 “always on” world presents individuals with increasing demands for attention from family, friends, co-workers and strangers alike. These factors complicate relationship network navigation and management tasks while simultaneously weakening the support fiber humans need for success, satisfaction and ease in so many aspects of their lives. The failure to manage interactions within personal relationship and resource networks has negative consequences and interferes with success, satisfaction and happiness, decreases productivity and increases emotional stress and turmoil.

Tools are available to manage personal-life networks, but they are not fully helpful. For example, social media (e.g., Facebook, MySpace, and Twitter) name and collect individuals within a social network. This facilitates efficient communication with those involved, but communication is only one aspect of navigation/management of relationships. Even the communication value is negated when some important people in within a personal network do not routinely use social media sites. By way of example, older people such as grandparents might miss, or learn only later, their grandchildren's milestones because those milestones are posted only on social media services that older people do not use frequently. Further, current social media services promote quantity of contacts, encouraging its users to “friend” each other, leading some users to compete with others for a quantity of “friends”, to the detriment of building quality, mutually supportive interactions with others.

Other currently available personal network management tools focus on a person's professional-life interactions/relationships. For example, LinkedIn collects and segments relationships, allowing for criteria-based searches and communications. Customer Relationship Management (CRM) software applications and services provide tools for organizing external prospects and customers, in data-centric sales-driven ways. However, LinkedIn does not allow users to codify other, more qualitative, aspects of user's contacts and CRMs are limited to external sales contacts, ignoring internal-company contacts altogether. Thus, these tools do not allow for a person to manage or enhance the purpose and value of the relationship/interaction/resource network element. Furthermore, LinkedIn does not encourage, and CRMs generally fail, to address key internal company relationship networks. Both fail to address personal-life networks.

Moreover, currently available relationship/interaction management tools and services do not afford users the ability, beyond aggregation and possibly classification (e.g., family group, work group, etc.) to quantitatively and qualitatively rank, rate, and describe the quality of a given interaction or relationship. Without this substantially important metric, users are often left on their own to identify which of the hundreds of interactions and relationships are of specific importance at any given point in time since currently available tools function as little more than contact directories. Additionally, existing practices, tools, and service are deficient in providing contextual information about a person's interaction/resource network that can be used by a user to more effectively navigate and manage such interactions and resources. By way of example, existing tools and services may offer specific recommendations to a user to add new connections to their personal relationship and resource network based on some demographic commonalities (e.g., attended the same school, work at the same company, attend the same church, etc.) however, such tools and services do not provide assistance about how to better navigate and manage a person's existing network of interactions and relationships (e.g., through research-based evidence, articles, blogs, professional service referrals) based on the network elements and how the user ranks/rates such interactions/relationships/resource network elements.

From the foregoing, it is appreciated that there exists a need for systems and methods that are aimed to ameliorate the shortcomings of existing practices.

### BRIEF DESCRIPTION OF THE DRAWING FIGURES

Other aspects, features, and advantages of described embodiments will become more fully apparent from the following detailed description, the appended claims, and the accompanying drawings in which like reference numerals identify similar or identical elements.

FIG. 1 is a block diagram of an exemplary computing environment in accordance with described embodiments;

FIG. 2 is a block diagram of an exemplary networked computing environment and the interaction among its components in accordance with described embodiments;

FIG. 3 is a block diagram showing the cooperation of exemplary components in accordance with described embodiments;

FIG. 4 is a block diagram showing the cooperation of exemplary cooperating parties in accordance with described embodiments;

FIG. 5 is a flow diagram showing a method for the aggregation and management of interaction/resource network data in accordance with described embodiments;

FIG. 6 is a flow diagram showing a method for the aggregation and management of interaction/resource network data for use by third party professional services providers in accordance with described embodiments;

FIG. 7 is a block diagram of an exemplary interaction/resource network data map in accordance with described embodiments;

FIG. 8 is a block diagram of an exemplary interaction/resource network data map showing an exemplary interaction scenario in accordance with described embodiments;

FIG. 9 is a flow diagram showing an illustrative method for an exemplary use case of an illustrative interaction/resource network platform in accordance with described embodiments;

FIGS. 10-12 are block diagrams showing features of an exemplary user interface operable for communication of data with an illustrative interaction/network data management platform for use in the aggregation and management of interaction/resource network data in accordance with described embodiments:

FIG. 13 is a flow diagram of an illustrative method for the interaction/network resource data processing and interaction referral data retrieval in accordance with described embodiments;

FIG. 14 is a flow diagram showing an illustrative method for the rating of various interaction/network resource data in accordance with described embodiments;

FIG. 15 is a flow diagram showing an illustrative method for performing benchmarking of various interaction/network resource data in accordance with described embodiments;

FIG. 16 is a block diagram showing an exemplary interaction/resource network data map in accordance with described embodiments;

FIG. 17 is a flow diagram showing an illustrative method for generating a data structure for the interaction/resource network data map shown in FIG. 16, in accordance with described embodiments;

FIG. 18 is a flow diagram showing an illustrative method for generating a graphical representation of the elements of the interaction/resource network data map shown in FIG. 16, in accordance with described embodiments;

FIG. 19 is a flow diagram showing an illustrative method for generating suggested elements of the interaction/resource network data map shown in FIG. 16, in accordance with described embodiments; and

FIG. 20 is a tree-like diagram showing an exemplary interaction/resource network data map for a particular user in accordance with described embodiments.

### DETAILED DESCRIPTION

Described embodiments provide several benefits associated with the identification and navigation/management of one's relationship and resource network elements (e.g., people). For example, it encourages an understanding of a person's total “relationship and resource network management” workload. Most people are generally unaware of the size or nature of that demand on their time and energy. Furthermore, with a proper implementation of interaction/resource network management, one can begin to distinguish between levels and types of relationships, facilitating better decision-making in interpersonal and network engagements. For example, it can help avoid “over-serving” less-important contact, thus preserving time and energy for oneself and/or for more relatively more important interactions/resource network elements.

Described embodiments provide for the aggregation and management of interaction/resource network (hereafter “I/RN”) data as expressed through a graphical data (e.g., network map) that, operatively and illustratively, provides compelling visual images that are efficient, impactful ways to understand the size, nature, inter-relationships and complexity of one's relationship network. The graphical representation helps a user to quickly assess competing, missing, and time consuming relationships which facilitates better decision-making throughout one's daily experience and results in capturing the scarcity and irreplaceable of commodities—especially, time.

Table 1 summarizes a list of acronyms employed throughout this specification as an aid to understanding the described embodiments:

TABLE 1

| | | | |
|---|---|---|---|
| ATM | Asynchronous Transfer | CPU | Central Processing |
| | Mode | | Unit |
| EDGE | Enhanced Data rates for | FC | Fibre Channel |
| | GSM Evolution | | |
| FTP | File Transfer Protocol | GPRS | General Packet Radio |
| | | | Service |
| GSM | Global System for Mobile | GUI | Graphical User |
| | communications | | Interface |
| HSPA | High Speed Packet Access | HTTP | HyperText Transfer |
| | | | Protocol |
| IGUI | Interactive GUI | ISDN | Integrated Services |
| | | | Digital Network |
| IrDA | Infrared Data Association | I/RN | Interaction/Resource |
| | | | Network |
| LAN | Local Area Network | LTE | Long Term Evolution |
| NAS | Network Attached Storage | PAN | Personal Area Network |
| PCI-E | Peripheral Component | PGP | Pretty Good Privacy |
| | Interconnect Express | | |
| PPP | Point-to-Point Protocol | RAM | Random Access Memory |
| ROM | Read Only Memory | SaaS | Software as a Service |
| SAN | Storage Area Network | SAS | Serial Attached SCSI |
| SATA | Serial Advanced | SCSI | Small Computer System |
| | Technology Attachment | | Interface |
| SOAP | Simple Object Access | SRIO | Serial Rapid Input/ |
| | Protocol | | Output |
| SSL | Secure Socket Layer | UFS | Universal Flash Storage |
| UMTS | Universal Mobile | USB | Universal Serial Bus |
| | Telecommunications | | |
| | System | | |
| VPN | Virtual Private Network | WAN | Wide Area Network |
| WAP | Wireless Application | WLAN | Wireless Local Area |
| | Protocol | | Network |
| WPAN | Wireless Personal Area | | |
| | Network | | |

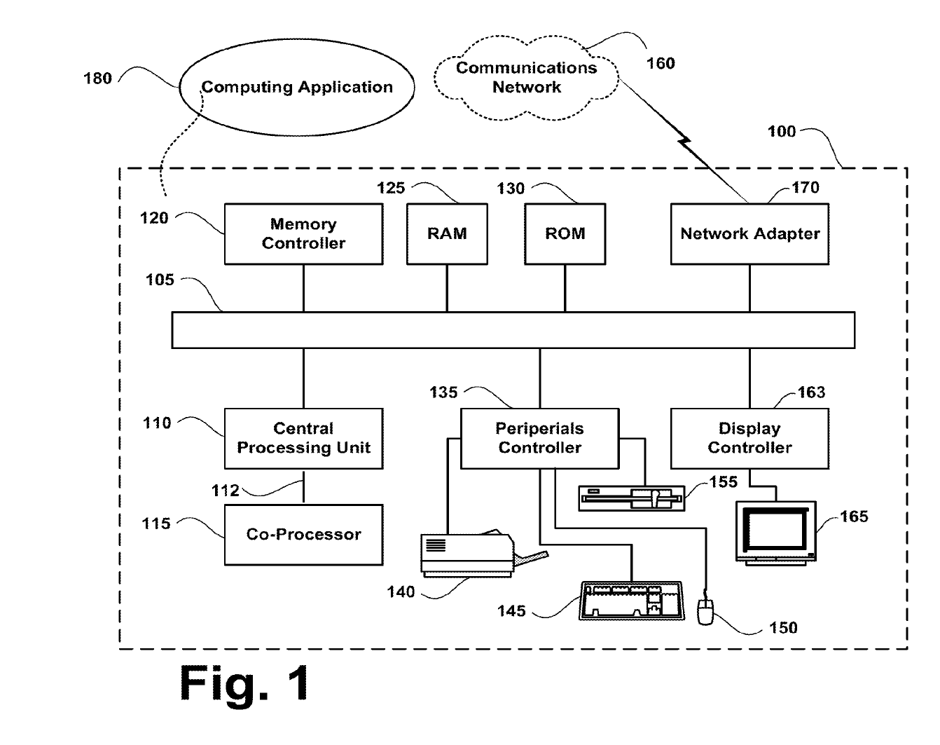

FIG. 1 depicts an exemplary computing system 100 in accordance with herein described system and methods. Examples of computing systems that may be represented by computing system 100 include, but are not limited to, personal computers, server computers, laptop computers, tablet computers, smart phones, and smart phone watches and other wearable computers. The computing system 100 is capable of executing a variety of computing applications 180. Computing application 180 might comprise a computing application, a computing applet, a computing program and other instruction set operative on computing system 100 to perform at least one function, operation, and/or procedure. Exemplary computing system 100 is controlled primarily by computer readable instructions, which may be in the form of software. The computer readable instructions might contain instructions for computing system 100 for storing and accessing the computer readable instructions themselves. Such software may be executed within central processing unit (CPU) 110 to cause the computing system 100 to do work. In many known computer servers, workstations and personal computers, a CPU 110 is implemented by micro-electronic chips CPUs called microprocessors. A coprocessor 115 is an optional processor, distinct from the CPU 110 that performs additional functions or assists the CPU 110. The CPU 110 may be connected to coprocessor 115 through interconnect 112. One common type of coprocessor is the floating-point coprocessor, also called a numeric or math coprocessor, which is designed to perform numeric calculations faster and better than the CPU 110.

In operation, the CPU 110 fetches, decodes, and executes instructions, and transfers information to and from other resources via the computer's main data-transfer path, system bus 105. Such a system bus connects the components in the computing system 100 and defines the medium for data exchange. Memory devices coupled to the system bus 105 include random access memory (RAM) 125 and read only memory (ROM) 130. Such memories include circuitry that allows information to be stored and retrieved. The ROMs 130 generally contain stored data that cannot be modified. Data stored in the RAM 125 can be read or changed by CPU 110 or other hardware devices. Access to the RAM 125 and/or ROM 130 may be controlled by memory controller 120. The memory controller 120 may provide an address translation function that translates virtual addresses into physical addresses as instructions are executed.

In addition, the computing system 100 can contain peripherals controller 135 responsible for communicating instructions from the CPU 110 to peripherals, such as, printer 140, keyboard 145, mouse 150, and data storage drive 155. Display 165, which is controlled by a display controller 163, is used to display visual output generated by the computing system 100. Such visual output may include text, graphics, animated graphics, and video. The display controller 163 includes electronic components required to generate a video signal that is sent to display 165. Further, the computing system 100 can contain network adaptor 170 which may be used to connect the computing system 100 to a communications network 160.

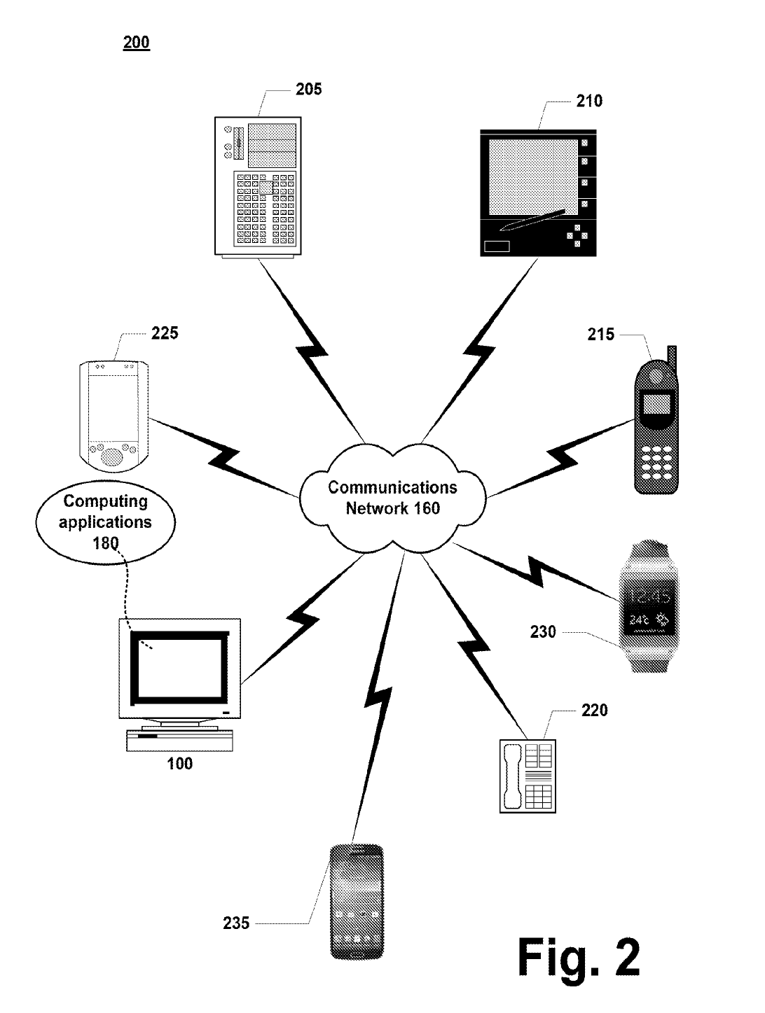

One or more computing systems 100, described above, can be deployed as part of a computer network. In general, the above description for computing environments and computing system 100 applies to both server computers and client computers deployed in a network environment. FIG. 2 illustrates an exemplary illustrative networked computing environment 200, with a server in communication with client computers via a communications network, in which the herein described apparatus and methods may be employed. As shown in FIG. 2, server computing environment 205 may be interconnected via a communications network 160 (which may be either of, or a combination of a fixed-wire or wireless network, such as a Local Area Network (LAN), a Wireless Local Area Network (WLAN), a Wide Area Network (WAN), a Personal Area Network (PAN), a Wireless Personal Area Network (WPAN), a telephony network such as a cellular network or a circuit switched network, an intranet, extranet, peer-to-peer network, virtual private network (VPN), the Internet, or other communications network, with a number of client computing environments such as tablet personal computer 210, mobile telephone 215, telephone 220, personal computer 202, and personal digital assistant 225, smart phone watch/personal goal tracker (e.g., FitBit) 230, smart phone 235. For example, communications network 160 might include one or more custom-designed communication links, and/or one or more links conforming to a standard communication protocol such as, for example, a cell relay asynchronous transfer mode (ATM) link, a packet switched (X.25, Frame-Relay) link, a circuit switched link such as a Point-to-Point Protocol (PPP) or Integrated Services Digital Network (ISDN) link, a Small Computer System Interface (SCSI) protocol link, a Serial Attached SCSI (SAS) protocol link, a Serial Advanced Technology Attachment (SATA) protocol link, a Fibre Channel (FC) link, a Peripheral Component Interconnect Express (PCI-E) link, a Serial Rapid I/O (SRIO) link, a Universal Flash Storage (UFS) link, an Infrared Data Association (IrDA) link, a Z-Wave link, a Zigbee link, a Universal Serial Bus (USB), a Wireless USB, an Ethernet link, an IEEE 802.11 (WiFi) link, an IEEE 802.15 (Bluetooth®) link, an IEEE 802.16 (WiMAX) link, an IEEE 802.22 (Whitespace) link, or a cellular link such as Long Term Evolution (LTE), High-Speed Packet Access (HSPA), Universal Mobile Telecommunications System (UMTS), Global System for Mobile communications (GSM), Enhanced Data rates for GSM Evolution (EDGE), or General Packet Radio Service (GPRS), or any other suitable communications link.

In a network environment in which the communications network 160 is the Internet, for example, server computing environment 205 can be dedicated computing environment servers operable to process and communicate data to and from client computing environments 100, 210, 215, 220, 225, 230, and 235 via any of a number of known protocols, such as, hypertext transfer protocol (HTTP), file transfer protocol (FTP), simple object access protocol (SOAP), or wireless application protocol (WAP). Additionally, networked computing environment 200 can utilize various data security protocols such as secured socket layer (SSL) or pretty good privacy (PGP). Each client computing environment 202, 210, 215, 220, 225, 230, and 235 can be equipped with computing applications 180 such as an operating system operable to support one or more other computing applications, such as a web browser (not shown), or other graphical user interface (not shown), or a mobile desktop environment (not shown) to gain access to server computing environment 205.

Server computing environment 205 may be communicatively coupled other computing environments (not shown) and receive data regarding the participating user's interactions/resource network. In an illustrative operation, a user (not shown) may interact with a computing application running on a client computing environments to obtain desired data and/or computing applications. The data and/or computing applications may be stored on server computing environment 205 and communicated to cooperating users through client computing environments 100, 210, 215, 220, 225, 230, and 235, over communications network 160. A participating user may request access to specific data and applications housed in whole or in part on server computing environment 205. These data may be communicated between client computing environments 100, 210, 215, 220, 225, 230, 235 and server computing environment for processing and storage. Server computing environment 205 may host computing applications, processes and applets for the generation, authentication, encryption, and communication data and applications and may cooperate with other server computing environments (not shown), third party service providers (not shown), network attached storage (NAS) and storage area networks (SAN) to realize application/data transactions.

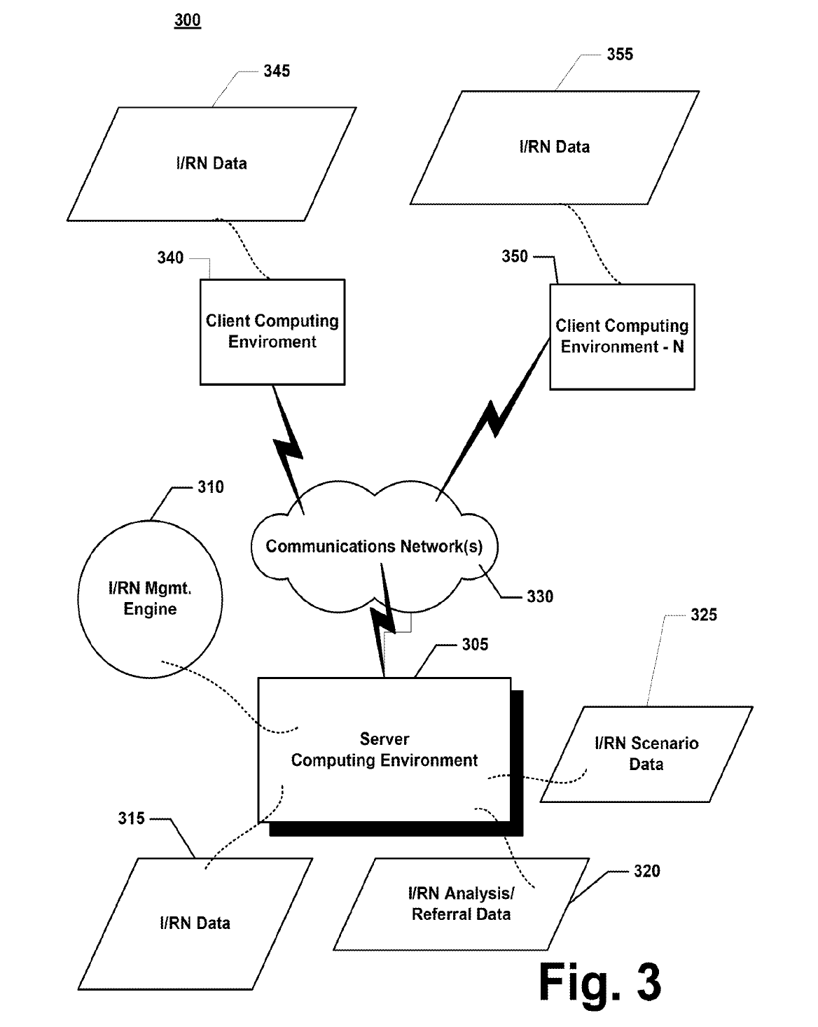

FIG. 3 shows an illustrative implementation of exemplary I/RN data management environment 300. As is shown, exemplary I/RN data management environment 300 comprises server computing environment 305, communications network(s) 330, and client computing environments 340 through 350. Additionally, as is shown, server computing environment 305 is operable to execute I/RN management engine 310 and store/retrieve data from various data stores including but not limited to I/RN data store 315, I/RN analysis/referral data store 320, I/RN scenario data store 325, and benchmark data store 330. Additionally, client computing environments 340 through 350 are operable to display and provide interactive controls to manipulate, change, and view real time interactive I/RN data 345 and 355.

In an illustrative operation, server computing environment 305 can receive various data inputs representative of one or more interactions/resource network elements from cooperating client computing environments 340 through 350 for storage in I/RN data store 315 and for processing by I/RN management engine 310 to generate real time interactive I/RN data 345 and 355 for communication to client computing environments 340 through 350 over communication network(s) 330. In the interest of brevity, only two client computing environments 340 and 350 are shown in FIG. 3. In should be understood that any number of client computing environments could be associated with the system 300.

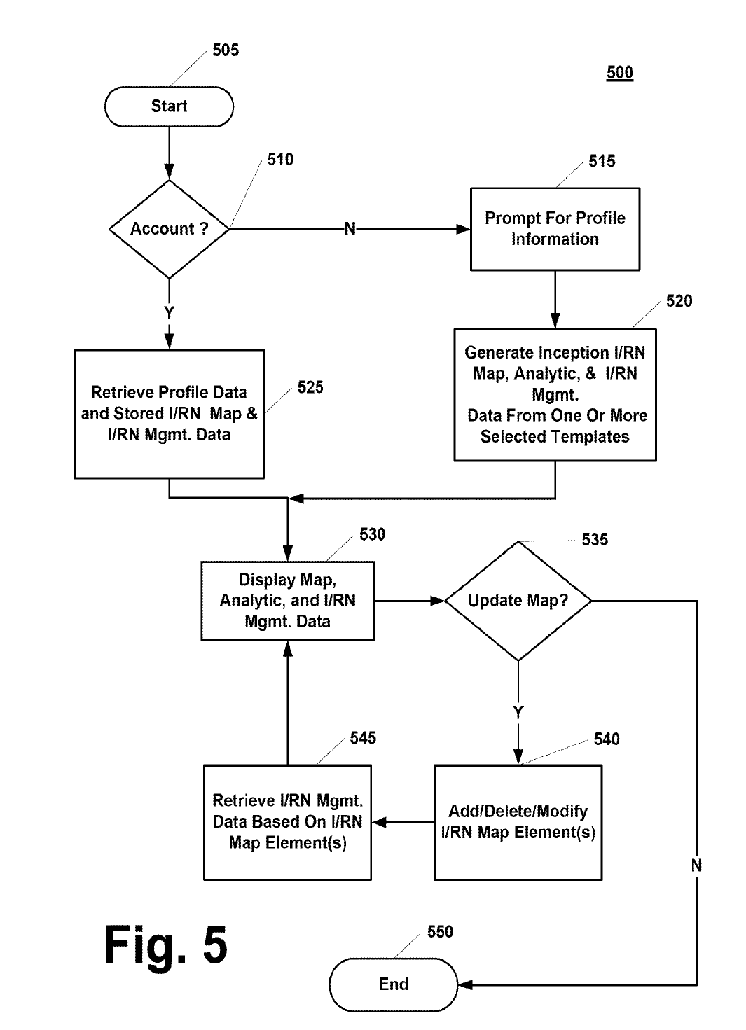

In the illustrative operation, I/RN management engine 310 can process received data inputs according to one or more interaction analytic/referral guidelines that can be retrieved from I/RN analysis/referral data store 320 to generate I/RN referral data (e.g., according to exemplary method 500 of FIG. 5). Additionally, in the illustrative operation, I/RN management engine 310 can process generated I/RN referral data (e.g., according to exemplary method 500 of FIG. 5) using one or more I/RN analysis/referral guidelines that can be retrieved from I/RN analysis/referral data store 320. Further, in the illustrative operation, I/RN management engine 310 can operatively retrieve for communication to one or more cooperating computing environments 340 through 350, data representative of one or more interaction scenarios and/or intelligent network recommendation data templates from I/RN scenario data store 325 that can be illustratively operatively selected based on the received inputted I/RN data.

In an illustrative implementation, the retrieved interaction scenarios and/or intelligent network element recommendation data template can comprise additional suggested interactions/resource network elements for processing by participating users (not shown) (e.g., if a participating user inputs that s/he is about to have a child as a life change event, a number of suggested relationships can be communicated for the users' consideration including doctor, nutritionist, mid-wife, party planner for a baby shower or in an alternate illustrative implementation, if a participating user inputs data representative of a family but does not include an element to represent a network connection with a estate attorney, the exemplary intelligent network recommendation data template may prompt the participating user with a question regarding the whether the participating user has a prepared any estate planning documents such as a will). Additionally, in the illustrative operation, I/RN management engine 310 can operatively retrieve for communication to one or more cooperating computing environments 340 through 350, data representative of one or more I/RN benchmarking data from I/RN benchmarking data store 325 that can illustratively operatively be representative of various benchmarks data as compared with the received inputted I/RN data.

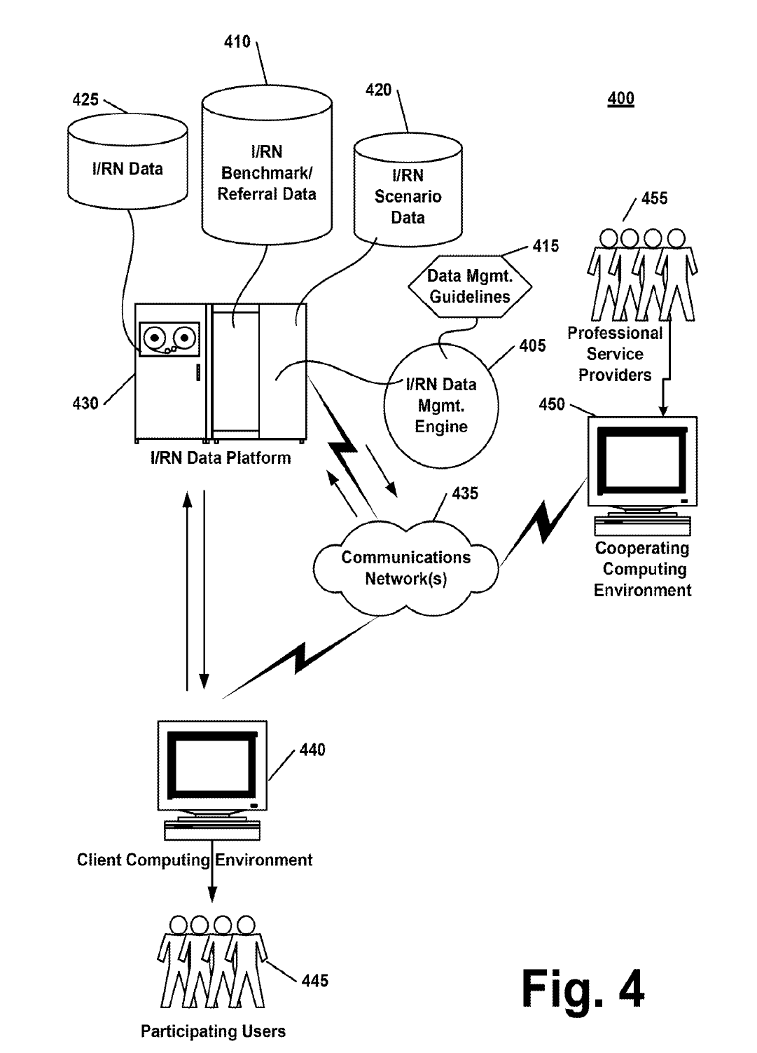

FIG. 4 shows an illustrative implementation of an exemplary I/RN data management environment 400. As is shown, I/RN data management environment 400 comprises I/RN data platform 430, cooperating with a number of data stores, user I/RN data store 425, I/RN benchmarking/referral data store 410, I/RN scenario data store 420, and executing I/RN data management engine 405 which contains one or more data management guidelines 415. Further, as is shown in FIG. 4, in the illustrative implementation, exemplary I/RN data management environment 400 comprises cooperating computing environments 440 and 450, and communications network 435.

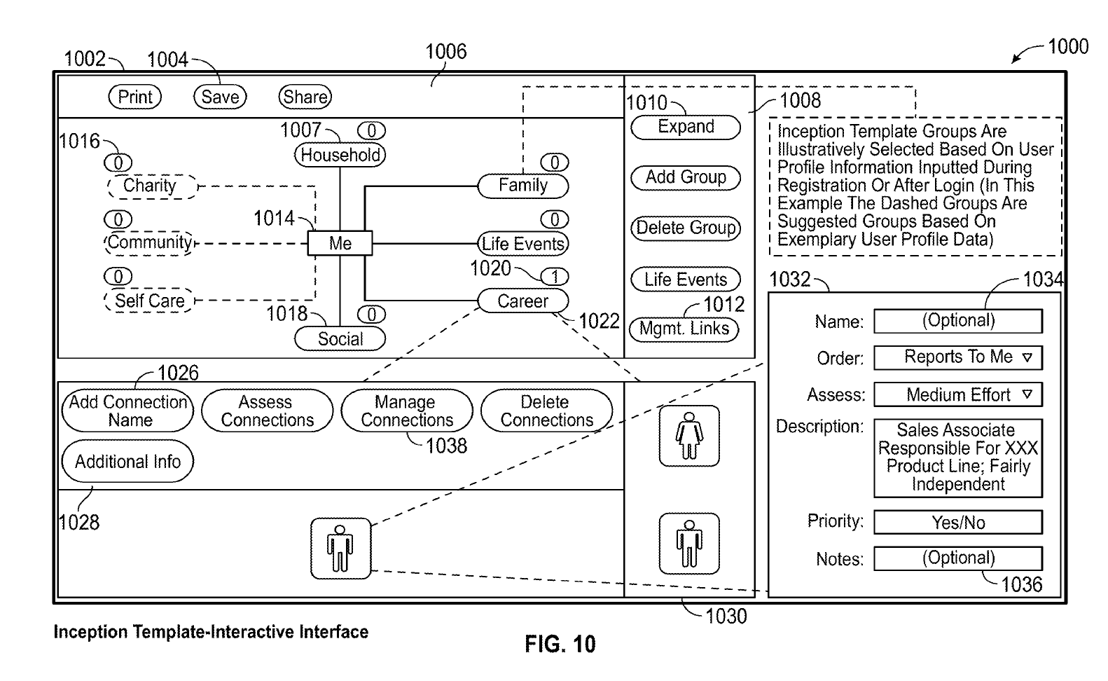

In an illustrative operation, participating users 445 can operatively interact with an interactive computing application (not shown but as described in FIGS. 10, 11, and 12) operable on client computing environment 440 to input data representative of one or more interactions/resource network elements (e.g., present, past, and/or future personal relationships, professional relationships, relationships with pets, relationships with objects, spiritual relationships, social relationships and other resource elements) for communication by client computing environment 440 over communications network 435 to I/RN data platform 430 for processing and storage. Responsive to the received I/RN data, I/RN data platform 430 can operatively store the received user I/RN data in user I/RN data store 425. In the illustrative operation, I/RN data management engine 405 can execute on I/RN data platform 430 according to one or more data management guidelines 415 to process the received I/RN data to operatively retrieve I/RN benchmark/referral data from I/RN benchmark/referral data store 410 and/or retrieve I/RN scenario data from I/RN scenario data store 420 for communication back to cooperating client computing environment 440 over communications network 435 to be consumed and digested by participating users 445.

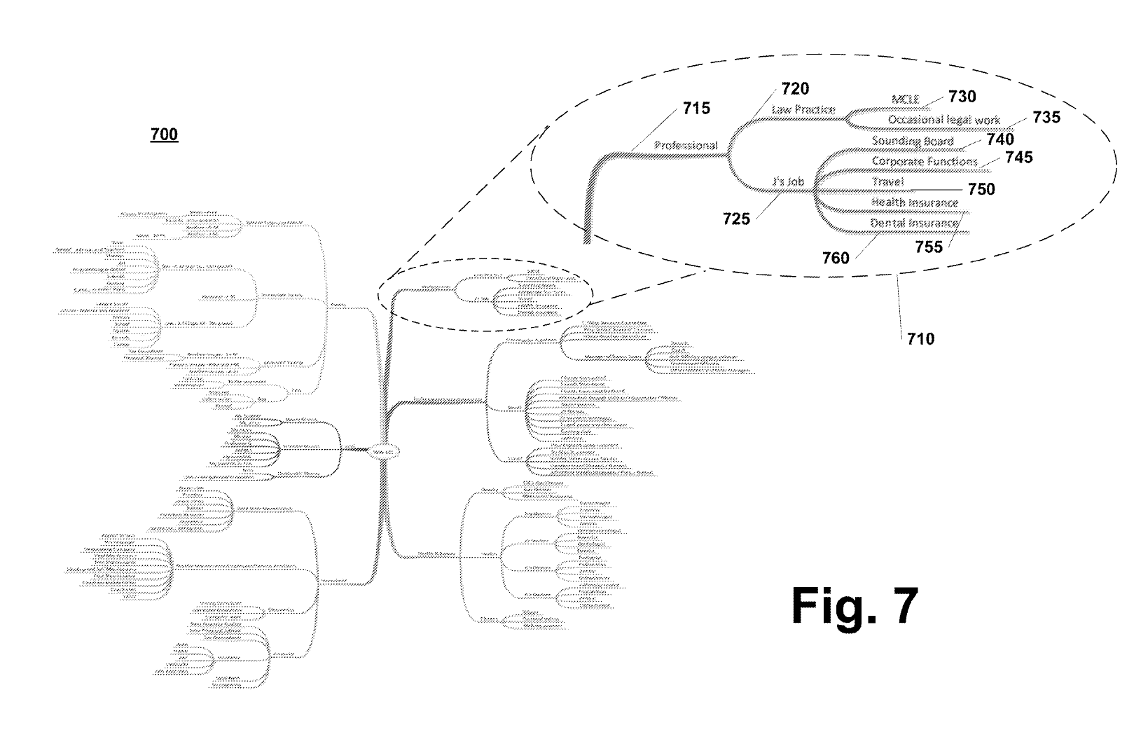

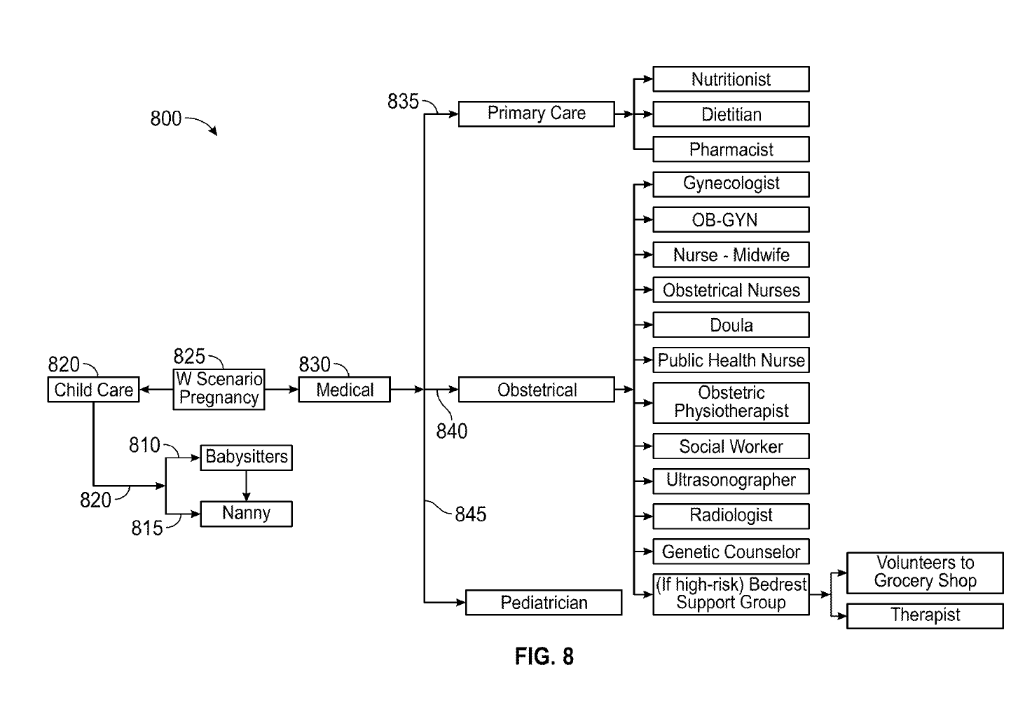

In an illustrative implementation, stored user I/RN data can comprise a network map (as illustratively described by FIGS. 7 and 8) showing the interplay/associations/connections/degree of separation among and between the inputted I/RN data elements. In the illustrative implementation, I/RN benchmarking/referral data can comprise data relevant to the management of the illustrative relationships and relationship types described herein as well as benchmarking data that can be used by the participating users 445 to compare their I/RN map with others who have some commonality (e.g., demographics, sociographics, econographics). In the illustrative implementation, interaction scenario data can comprise suggested additional interactions/resource network elements for addition to a participating user's I/RN map based on the occurrence of a near future life event (e.g., the birth of a child, the adoption of a pet, the care of an elderly parent).

In another illustrative operation, and as is shown in FIG. 4, professional services providers (e.g., lawyers, accountants, financial advisors, healthcare professionals) 455 can operatively submit a request for their clients' I/RN data (i.e., if available and if authorized) using cooperating computing environment 450 over communications network 435 from I/RN data platform 430 to allow the professional service providers 455 better understand the types, numbers, and quality of the I/RN elements of their clients as part of providing requested professional services. By way of example, a trust and estate lawyer can be authorized by his/her client to have access to the client's I/RN map and associated data such that the trust and estate lawyer can best understand the direct and number of relationships that their client has to better provide counsel on various trust and estate planning issues/matters. Responsive to the request, I/RN data platform 430 can operatively retrieve various I/RN data for communication (i.e., if available and/or if authorized by the owner of the I/RN data—e.g., participating user 445) to the requesting professional services providers 455 using cooperating computing environment 450 over communications network 435.

FIG. 5 shows exemplary method 500 describing illustrative processing performed by exemplary I/RN data management engine 405 of FIG. 4 in connection with processing data for generating and managing the illustrative I/RN map data described in FIG. 4. As is shown, processing begins at block 505 and proceeds to block 510 where a check is performed to determine whether a participating user has an account. If the check at block 510 indicates that the participating user does have an account, process proceeds to block 525, where the participating user's profile and I/RN stored map data is retrieved. If, however, the check at block 520 indicates that the participating user does not have an account, processing proceeds to block 515 where the user is prompted to input selected profile information. In an illustrative implementation, the selected profile information can comprise demographic data and various preferences for a participating user. From block 515, processing proceeds to block 520 where an inception I/RN map as well as analytic and I/RN management data are generated for that particular user. In an illustrative implementation, the inception I/RN map can be generated using one or more map templates that are selected based on the participating user's profile information.

From either block 520 or 525, processing proceeds to block 530 where the retrieved I/RN map or generated I/RN inception map, as well as retrieved/generated analytic, and I/RN management data is displayed to the participating user. A check is then performed at block 535 to determine if the retrieved/generated I/RN map required updating. If the check at block 535 indicates that the I/RN map does not require updating, processing terminates at block 550. If, however, the check at block 535 indicates that the retrieved/generated I/RN map requires updating, processing proceeds to block 540 where one or more I/RN map elements are added/deleted/modified in the retrieved/generated I/RN map. Processing then proceeds to block 545 where the I/RN referral data (e.g., data providing insights regarding the management of relationships) is retrieved based on the updated I/RN map elements.

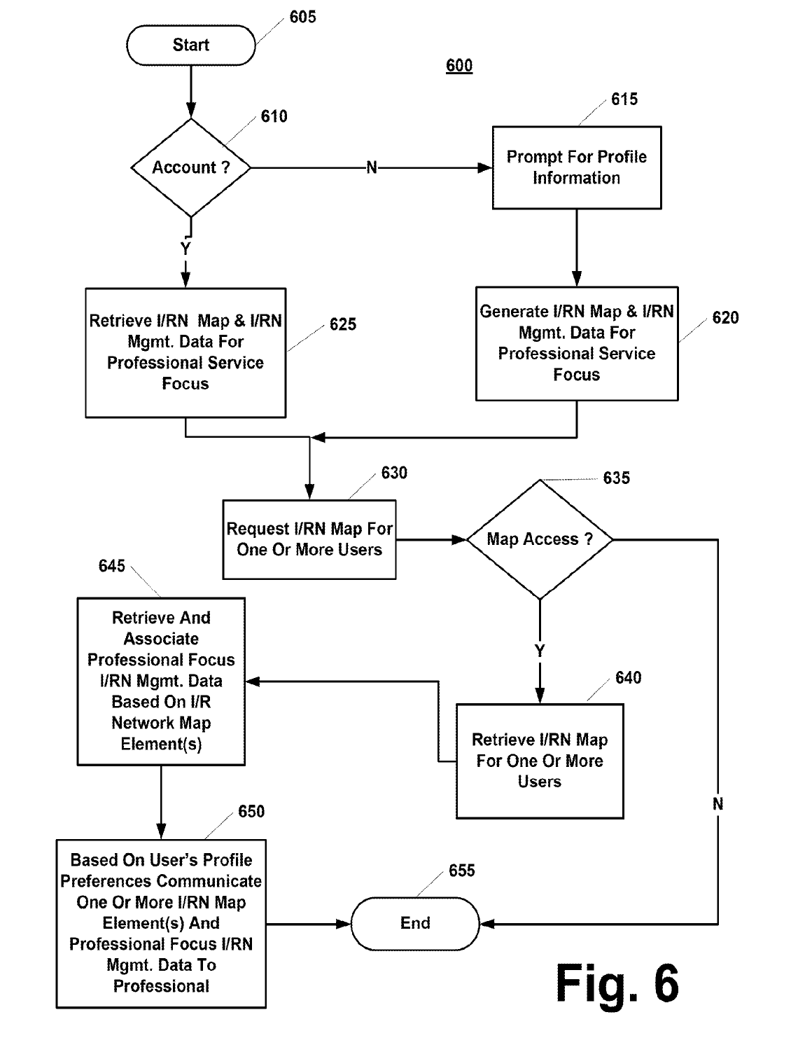

FIG. 6 shows exemplary method 600 describing illustrative processing performed when processing data requests by exemplary I/RN data platform 430 of FIG. 4 for submitted by participating professional service providers as described in FIG. 4. As is shown, processing begins at block 605 and proceeds to block 610 where a check is performed to determine if the participating professional services provider has an account. If the check at block 610 indicates the professional services provider does have an account, processing proceeds to block 625 where I/RN map and referral data for a selected professional services focus is retrieved. If, however, the check at block 610 indicates that the requesting professional services provider does not have an account, processing proceeds to block 615 where the professional services provider is prompted to input profile information (e.g., demographics, preferences, professional services designation, etc.). From block 615, processing proceeds to block 620 where an I/RN map and I/RN referral data is generated having a selected professional services focus. From either block 620 or 625, processing proceeds to block 630 where an I/RN map is requested for a selected participating user (e.g., client).

At block 630, a check is performed to determine whether the requesting professional services provider has been granted access by the participating user to retrieve the participating user's I/RN map and I/RN referral data. If the check at block 635 indicates that the requesting professional services provider does not have the requisite authorization, processing terminates at block 655. However, if the check at block 635 indicates that the requesting professional services provider does have the requisite authorization, processing proceeds to block 640 where the participating user's I/RN map is retrieved and then professional focus data is associated based on the I/RN map elements with the retrieved I/RN map data at block 645 and communicated, in whole or in part, based on the participating user's communication preferences to the requesting professional services provider at block 650. Processing then terminates at block 655.

In an illustrative implementation, a participating user may authorize their psychologist to have access to a portion of their I/RN map to allow their psychologist to gain insight into the client's personal network of relationships and resources. This insight could be invaluable to the psychologist for diagnostic as well as treatment plan purposes for the participating user.

FIG. 7 shows an illustrative graphical representation of an exemplary I/RN map for an exemplary participating user. As is shown, I/RN map 700 comprises numerous I/RN data types (e.g., family, professional, household) as well as numerous I/RN map elements within each data types that represent one or more I/RN elements (e.g., relationships, resources). As is further shown in FIG. 7, magnification circle 710 magnifies the I/RN map elements found, by way of example, in the “Professional” I/RN data type 715 of I/RN map 700. As is shown in magnification circle 710, the “Professional” I/RN data type 715 comprises further sub-types. In the example shown, the “Professional” I/RN data type 715 has two sub-types which can represent more details relative to the original I/RN data type. These two-sub types 720 and 725, as shown, are labeled “Law Practice” and “J's Job”, respectively. Associated with these sub types are various selected I/RN map elements 730, 735, 740, 745, 750, 755, and 760. These I/RN map elements are descriptions of resource network elements for the exemplary participating user for those specific professional I/RN data sub-types. In an illustrative implementation, these resource network elements can comprise functions, activities, operations, and/or personnel that have to be managed in context to the I/RN data type and/or I/RN data sub-type.

FIG. 8 shows an illustrative graphical representation of an exemplary I/RN scenario 800 that can be presented to a participating user as they build and/or manage their I/RN map. In FIG. 8, the illustrative I/RN scenario that is presented relates to a pregnancy scenario. As is shown, exemplary I/RN scenario comprises various I/RN data types 820 and 830 as well as various I/RN sub-types 810, 815 and 835, 840, and 845 for each I/RN data type respectively that may come to light in the participating user I/RN map through this life change event 825 (i.e., pregnancy). In the example offered, the participating user is going to have to consider adding various I/RN elements to their I/RN map which logically come with such a life event such as medical personnel (e.g., primary care, obstetrical, and pediatric) as well as possibly child care personnel (e.g., baby sitters and nannies). The herein described systems and methods contemplate the storage of numerous templates that have populated therein suggested I/RN map elements based on the various I/RN scenarios that a participating user may encounter as life events that can range from graduating high school to marriage to losing a parent and so on.

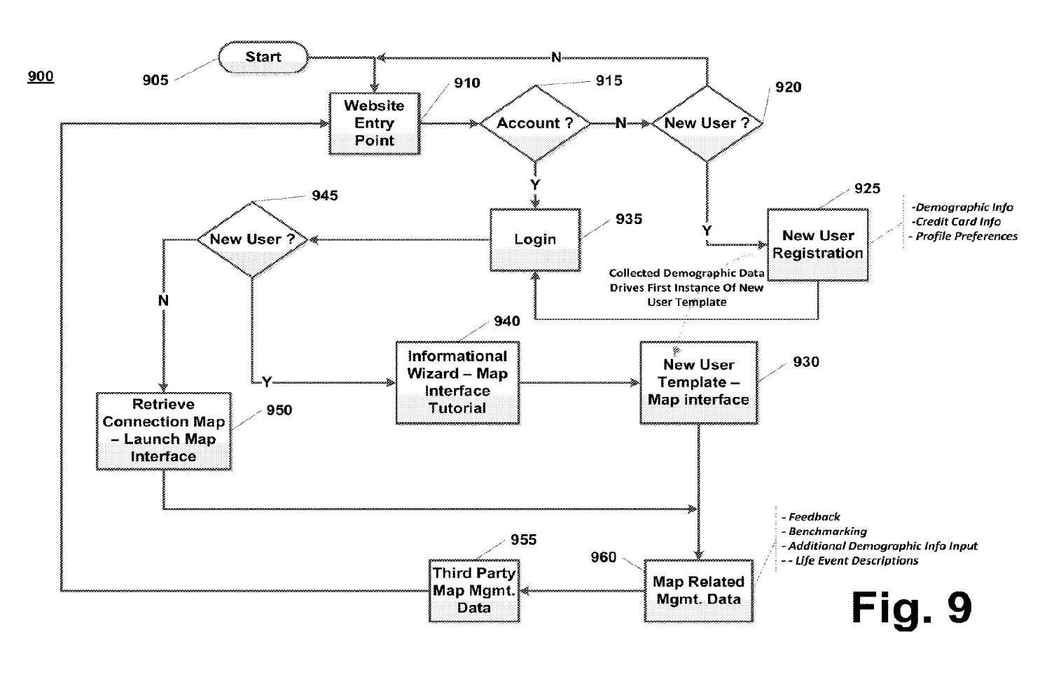

FIG. 9 shows exemplary method 900 performed by exemplary I/RN data platform 430 of FIG. 4 as expressed as part of a web based computing application. As is shown, processing begins at block 905 and proceeds to block 910 where a participating user navigates to a home page acting as the point of entry into the exemplary web-based application. From there processing proceeds to block 910 where a check is performed to determine if the participating user has an account on the platform. If the check at block 910 indicates that the participating user does not have an account, processing proceeds to block 920 where another check is performed to determine if the participating user is a new user to the platform. If the check at block 920 indicates that the user is not a new user, processing reverts back to block 910 and continues from there. However, if the processing at block 920 indicates that the it is a new user, processing proceeds to block 925 where the new user is prompted to input registration information (e.g., demographic information, credit card information, profile preferences, etc.). In an illustrative implementation, the registration information inputted at block 925 can be operatively used as a basis to generate the first instance of the I/RN map to be generated for the participating user (e.g., if the participating user is married with kids, specific selected inception I/RN templates can be retrieved so as to facilitate the required data input to begin building the I/RN map). Processing from block 925 then proceeds to block 935 and proceeds from there.

If the check at block 915 indicates that the participating user has an account, processing proceeds to block 935 where the participating user is prompted to enter their login credentials. Processing then proceeds to block 945 where a check is performed again to determine if the participating user is a first time user after their first login. If the check at block 945 indicates that it is not a first time user, processing proceeds to block 950 where the user's I/RN map is retrieved and the map interface is launched. After block 950, I/RN referral data is presented at block 960 and third party map management data at block 955 is provided to the participating user. If the check at block 945 indicates that it is a first time user after a first time login, processing proceeds to block 940 where a series of instructions in the form an information wizard are communicated to the participating user to provide instructions regarding the building of the I/RN map using the exemplary user interfaces (as described in FIGS. 10-12). From there processing proceeds to block 930 where a new user I/RN inception map template (e.g., selected based on the user's profile information) is retrieved for interaction and the map interface (as described in FIGS. 10-12) is launched. From there based on the I/RN inputted map elements (not shown) I/RN referral data is presented at block 960 and third party map management data at block 955 is provided to the participating user.

In an illustrative implementation, I/RN referral data can comprises content concerning the management of relationships/resources (e.g., an article regarding the pay scale for baby sitters for a participating user who has identified she/he has children in the I/RN map). In the illustrative implementation, the third party map management data can comprise suggested content from professional service providers regarding specific operations, features, activities, efforts, etc. regarding one or more inputted I/RN map elements (e.g., a legal news alert regarding investment properties for a participating user who included a housekeeper associated with the participating user's vacation villa). Processing then proceeds from block 955 and reverts back to block 910 and continues from there. However, if the check at block 945 indicates that it is not a user, the I/RN map is retrieved for the participating user and the map interface is launched as described in FIGS. 10-12.

FIG. 10 is a block diagram of an exemplary interactive graphical user interface (IGUI) for use by a participating user on a cooperating computing environment to input, retrieve, update, and navigate I/RN map data from/to exemplary I/RN data platform 430 of FIG. 4. As is shown, I/RN map interface 1000 comprises data window 1002 having various navigations controls 1006 and 1008 that provide specific operations and features such as 1004, 1010, and 1012 (e.g., create new I/RN data types, retrieve I/RN scenarios, retrieve I/RN referral data). It is appreciated that the inventive concepts described herein are not limited to any specific navigation control mechanism but can incorporate best of breed navigation controls including drag and drop navigation controls. In the I/RN map interface, data window 1002 is operable to graphically display one or more I/RN data types 1007, 1014, 1018, 1022 that can have associated contextual data also displayed such as the number of elements 1016 and 1020 for each I/RN data type. As is further shown in FIG. 10, upon the interaction with one or more of the listed I/RN data types 1007, 1014, 1018, 1022, operatively, a second window 1028 that allows the participating user to manage the I/RN elements and provide additional descriptive and contextual data for the I/RN map element.

As is shown, second window 1028 can comprise navigation control areas 1030 and 1026 that can comprise various operations and features such as 1030 and 1038. In the illustrative implementation, the operations and features can allow a participating user to add, delete, modify, manage I/RN map elements as well as enter descriptive information regarding each of the I/RN map elements as shown as a third window dialog 1032 containing various data 1034 and 1036 that can be variably inputted using various data input fields (e.g., comment box, drop down list, radio buttons).

In an illustrative implementation, I/RN map interface 1000 can be operative to display an inception I/RN map. In this context, an inception I/RN map can have pre-populated I/RN data types that are selected based on the participating user's profile information such that, by way of example, a participating user who is employed, married with children, and is a national guard reservist could be presented with an I/RN inception map having I/RN data types for family, profession, and military designations.

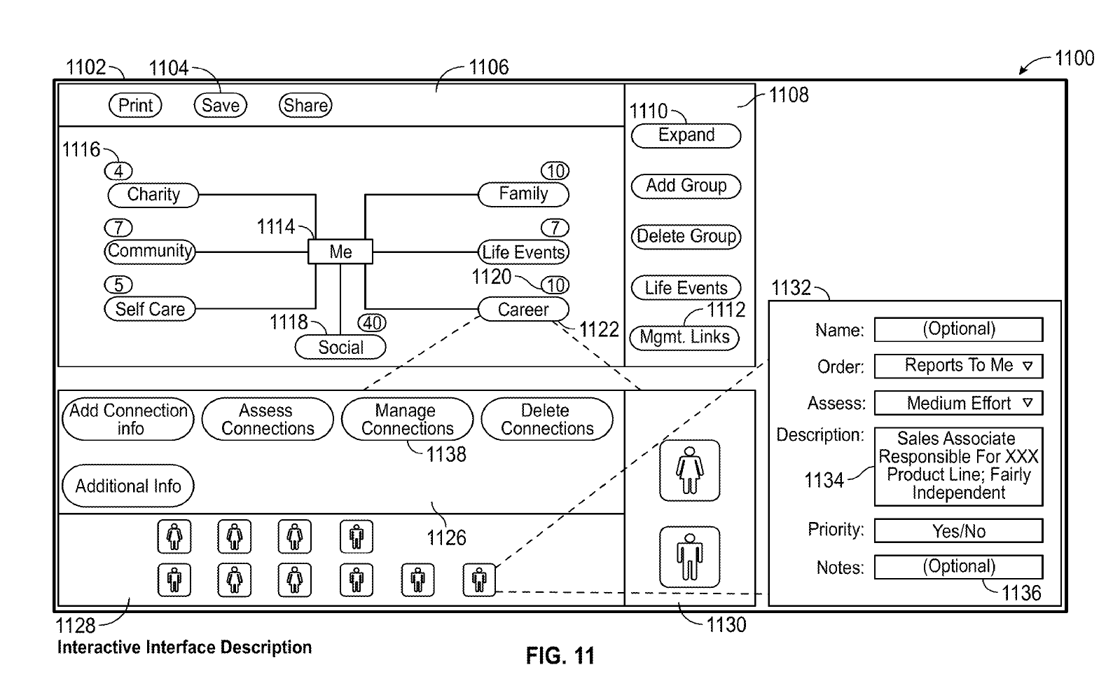

FIG. 11 is a block diagram of an exemplary interactive graphical user interface (IGUI) for use by a participating user on a cooperating computing environment to input, retrieve, update, and navigate I/RN map data from/to exemplary I/RN data platform 430 of FIG. 4. As is shown, I/RN map interface 1100 comprises data window 1102 having various navigations controls 1106 and 1108 that provide specific operations and features such as 1104, 1110, and 1112 (e.g., create new I/RN data types, retrieve I/RN scenarios, retrieve I/RN referral data, etc.). It is appreciated that the inventive concepts described herein are not limited to any specific navigation control mechanism but can incorporate best of breed navigation controls including drag and drop navigation controls. In the I/RN map interface, data window 1102 is operable to graphically display one or more I/RN data types 1114, 1118, 1122 that can have associated contextual data also displayed such as the number of elements 1116 and 1120 for each I/RN data type. As is further shown in FIG. 11, upon the interaction with one or more of the listed I/RN data types 1114, 1118, 1122, operatively, a second window 1128 that allows the participating user to manage the I/RN elements and provide additional descriptive and contextual data for the I/RN map element.

As is shown, second window 1128 can comprise navigation control areas 1130 and 1126 that can comprise various operations and features such as 1130 and 1138. In the illustrative implementation, the operations and features can allow a participating user to add, delete, modify, manage I/RN map elements as well as enter descriptive information regarding each of the I/RN map elements as shown as a third window dialog 1132 containing various data 1134 and 1136 that can be variably inputted using various data input fields (e.g., comment box, drop down list, radio buttons, etc.).

In an illustrative implementation, I/RN map interface 1100 can be operative to display and navigate an existing/retrieved I/RN map. In this context, the retrieved I/RN map comprises historical I/RN data types that the participating user has previously inputted and which can be modified through the use of navigation controls of I/RN map interface 1100.

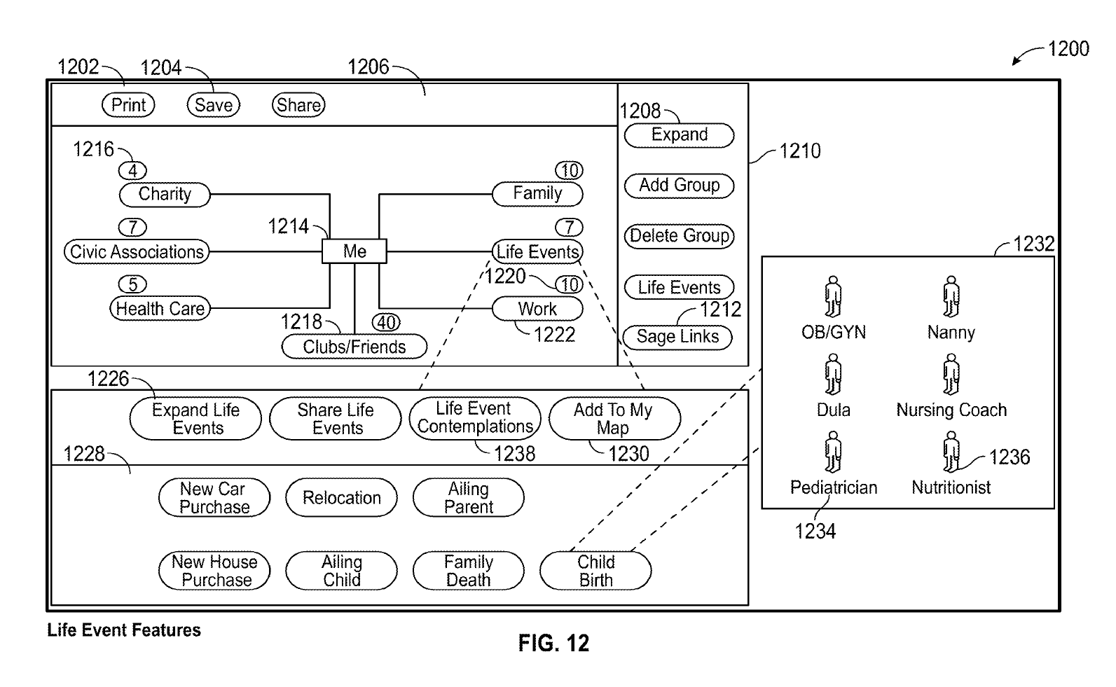

FIG. 12 is a block diagram of an exemplary interactive graphical user interface (IGUI) for use by a participating user on a cooperating computing environment to input, retrieve, update, and navigate I/RN map data from/to exemplary I/RN data platform 430 of FIG. 4. As is shown, I/RN map interface 1200 comprises data window 1202 having various navigations controls 1206 and 1208 that provide specific operations and features such as 1204, 1210, and 1212 (e.g., create new I/RN data types, retrieve I/RN scenarios, retrieve I/RN referral data, etc.). It is appreciated that the inventive concepts described herein are not limited to any specific navigation control mechanism but can incorporate best of breed navigation controls including drag and drop navigation controls. In the I/RN map interface, data window 1202 is operable to graphically display one or more I/RN data types 1214, 1218, 1222 that can have associated contextual data also displayed such as the number of elements 1216 and 1220 for each I/RN data type. As is further shown in FIG. 12, upon the interaction with a life event data type 1220, operatively, a second window 1228 that allows the participating user to select from various I/RN scenarios to allow the participating user to review suggested I/RN map elements associated with the selected life event, manage the suggested I/RN elements and provide additional descriptive and contextual data for the I/RN map element.

As is shown, second window 1228 can comprise navigation control area 1226 that can comprise various operations and features such as 1230 and 1238. In the illustrative implementation, the operations and features can allow a participating user to add, delete, modify, manage I/RN map elements as well as enter descriptive information regarding each of the I/RN map elements as shown as a third window dialog 1232 containing various suggested I/RN scenario map elements 1234 and 1236 that can be added to the participating user's I/RN map using navigation controls 1230.

In an illustrative implementation, I/RN map interface 1200 can be operative to display and navigate an existing/retrieved I/RN map and suggested I/RN scenario map elements. In this context, the retrieved I/RN map comprises historical I/RN data types that the participating user has previously inputted and which can be modified through the use of navigation controls of I/RN map interface 1200. By way of example, as is shown in FIG. 12, the life event data type can be selected which then retrieves various I/RN scenarios such as child birth. In this context, the child birth I/RN scenario has various selected I/RN map elements to which it is already associated including, for example, nannies, nursing coaches, etc.

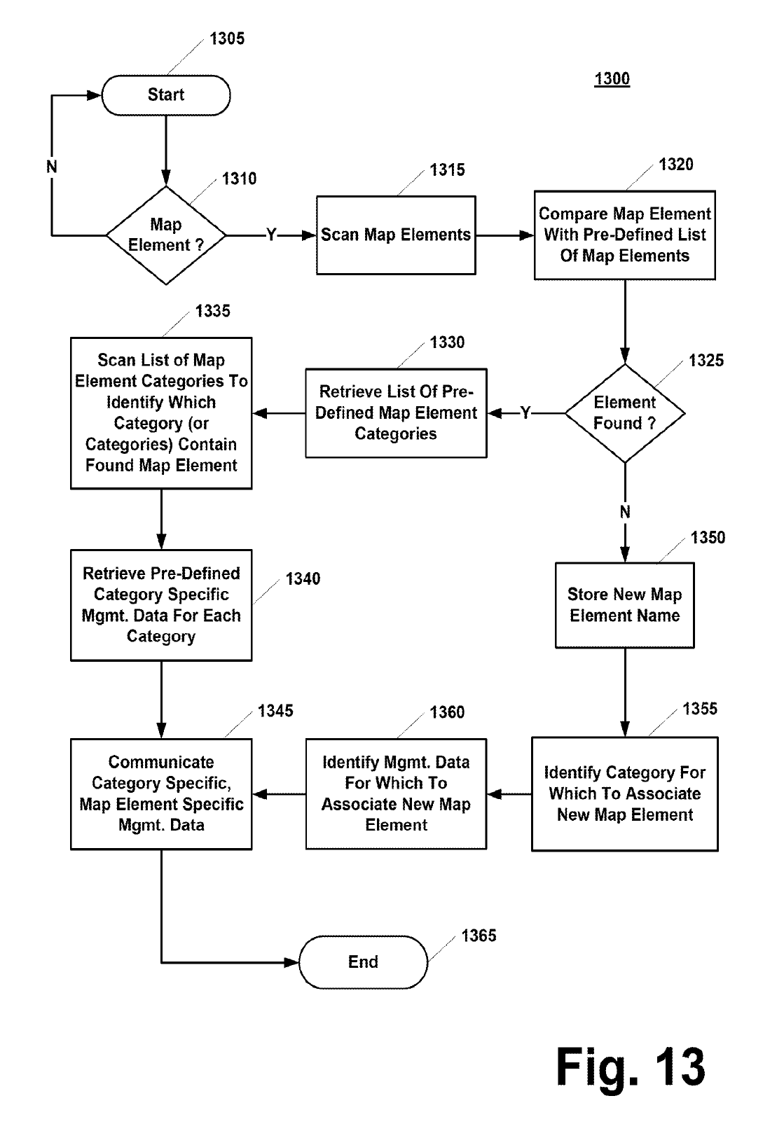

FIG. 13 is a flow diagram of exemplary method 1300 for use by exemplary I/RN data platform 430 of FIG. 4 in processing inputted I/RN map data to select specific I/RN referral data. As is shown, processing begins at block 1305 and proceeds to block 1310 where a check is performed to determine if there is a map element in the I/RN map. If the check at block 1310 indicates that there is not a map element present, processing reverts back to block 1305 and proceeds from there. However, if the check at block 1310 indicates that there is a map element, processing proceeds to block 1315 where the I/RN map's map elements are scanned and compared against a list of pre-defined map elements at block 1320. From there a check is performed at block 1325 to determine if the scanned map element is found on the pre-defined list. If the comparison proves true, processing proceeds to block 1330 where a list of pre-defined I/RN map data types are retrieved and scanned at block 1335 to determine which I/RN data type to associate the inputted I/RN map element. From there, I/RN data type specific referral data is retrieved at block 1340 and communicated at block 1345 to the participating user. Processing then terminates at block 1365.

However, if the check at block 1325 indicates that the inputted map element is not found in the list of pre-defined map elements, processing proceeds to block 1350 where the new map element name is stored. From there processing proceeds to block 1355 where the I/RN category is identified for which to associate to the newly inputted map element. From there processing proceeds to block 1360 where I/RN referral data is identified for which to associate to the newly inputted map element. Processing proceeds to block 1345 and continues from there.

In an illustrative operation, method 1300 can be described as receiving data representative of a plurality of I/RN elements, where each of the I/RN elements comprises a present, past, and/or future personal relationship, professional relationship, relationships with a pet, relationships with an object, spiritual relationship, social relationship or other resource. From there, at least one I/RN data type is selected based on at least one characteristic of the received I/RN element and is associated with one of the plurality of received I/RN elements. In the illustrative operation, method 1300 can also generate at least one I/RN contextual data association, where each of the at least one I/RN contextual data associations define an association between at least two of the plurality of I/RN elements based on at least one characteristic of each of the at least two of the plurality of I/RN elements. In an illustrative implementation, the one or more characteristics of the I/RN elements can comprise data representative of the degree of separation between one or more I/RN elements along the tree of consanguinity, data representative of the placement of an I/RN element on a selected organizational chart, data representative of the type of relationship represented by the I/RN element data, data representative of the age of the relationship represented by the I/RN element data, data representative of the demographics of the I/RN element comprising age data, gender data, income data, location data, education data, and career data. By way of example, an I/RN data type can comprise a category of relationships (e.g., family, work, faith), an I/RN map element can comprises people that would be present such relationship categories (e.g., brother, sister, boss, priest), and a contextual data association can comprise the number of elements in any given category. In the illustrative operation, a graphical representation can then be generated that shows the plurality of I/RN elements, the at least one I/RN contextual data association and the at least one characteristics of the plurality of I/RN elements for which an association is defined.

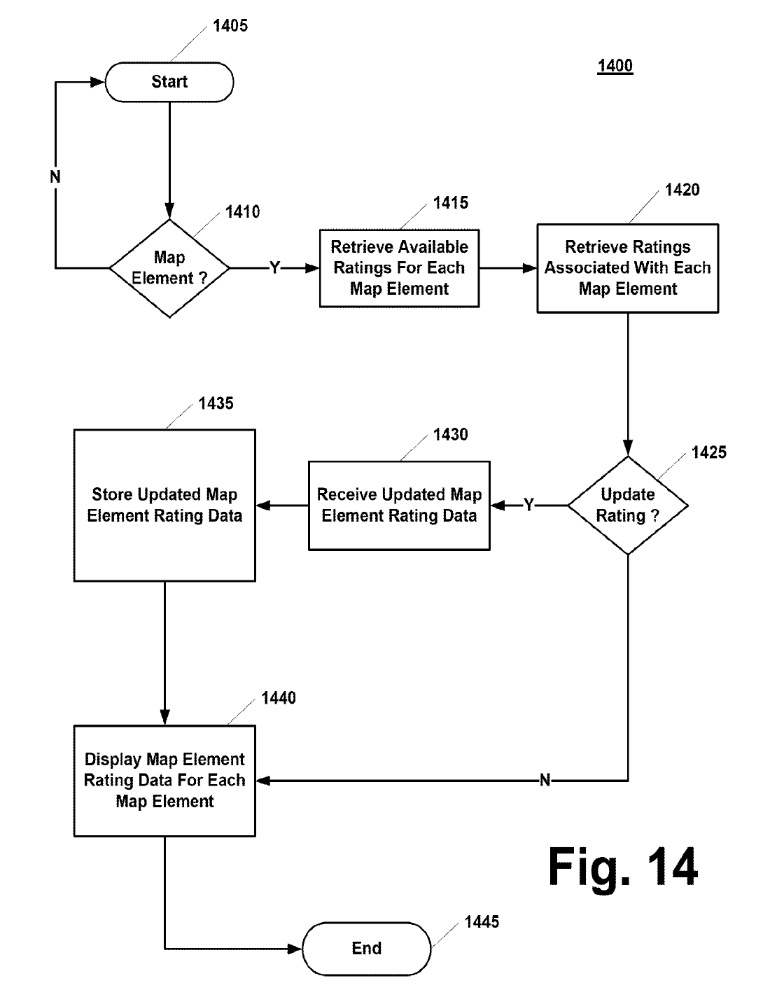

FIG. 14 shows exemplary method 1400 for use by exemplary I/RN data platform 430 of FIG. 4 in processing rating data for I/RN map elements. As is shown, processing begins at block 1405 and proceeds to block 1410 where a check is performed to determine if there is a map element. If a map element is not present, processing reverts back to block 1405 and continues from there. If there is a map element present, processing proceeds to block 1415 where the available ratings for the map element is retrieved as well as any historical map element ratings that may have been associated with the map element are retrieved at block 1420. A check is then performed at block 1425 to determine if the retrieved map element rating requires update. If an update is required, processing proceeds to block 1430 where updated map element data is received. The updated map element rating data is stored at block 1435 and communicated for display at block 1440. However, if the check at block 1425 indicates that a rating update is not requested, processing proceeds to block 1440. Processing then terminates at block 1445.

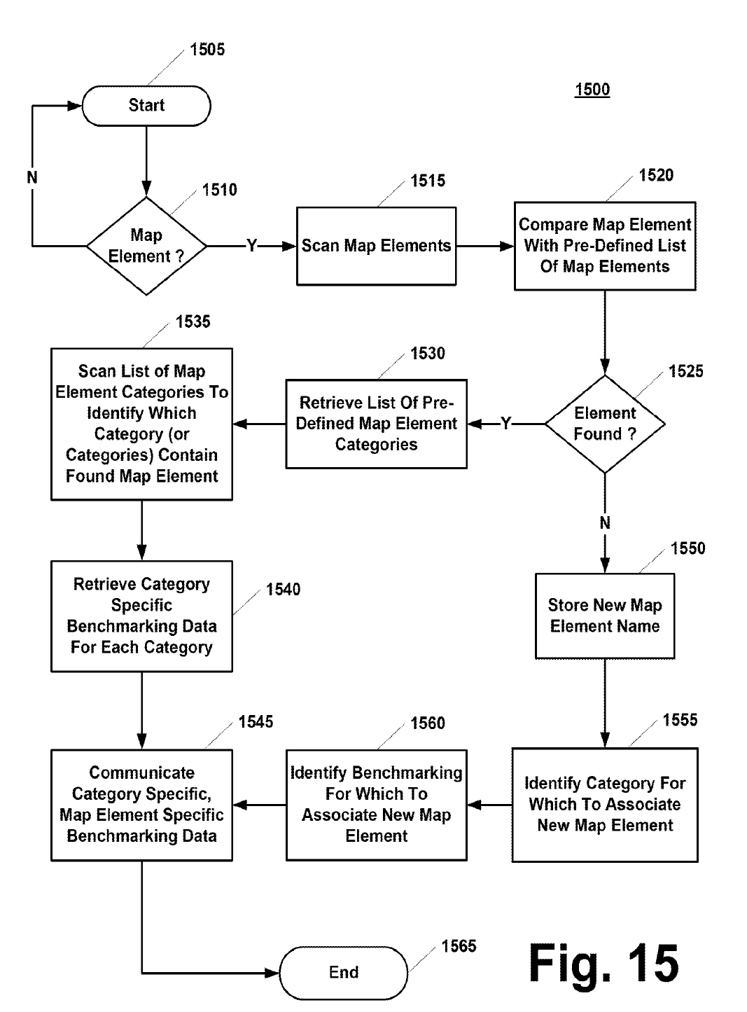

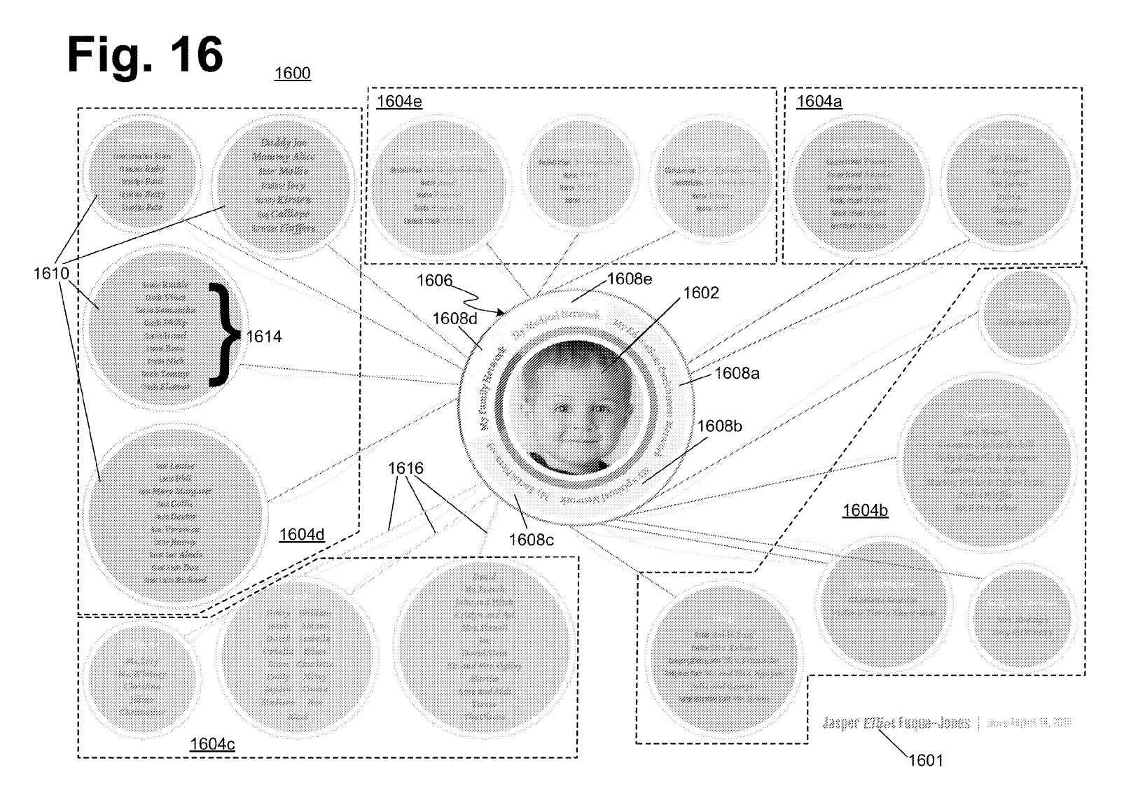

FIG. 15 is a flow diagram of exemplary method 1500 for use by exemplary I/RN data platform 430 of FIG. 4 in processing inputted I/RN map data to select specific I/RN benchmarking data. As is shown, processing begins at block 1505 and proceeds to block 1510 where a check is performed to determine if there is a map element in the I/RN map. If the check at block 1510 indicates that there is not a map element present, processing reverts back to block 1415 and proceeds from there. However, if the check at block 1510 indicates that there is a map element, processing proceeds to block 1515 where the I/RN map's map elements are scanned and compared against a list of pre-defined map elements at block 1520. From there a check is performed at block 1525 to determine if the scanned map element is found on the pre-defined list. If the comparison proves true, processing proceeds to block 1530 where a list of pre-defined I/RN map data types are retrieved and scanned at block 1535 to determine which I/RN data type to associate the inputted I/RN map element. From there, I/RN data type specific benchmarking data is retrieved at block 1540 and communicated at block 1355 to the participating user. Processing then terminates at block 1365.

However, if the check at block 1525 indicates that the inputted map element is not found in the list of pre-defined map elements, processing proceeds to block 1550 where the new map element name is stored. From there processing proceeds to block 1555 where the I/RN data type is identified for which to associate the newly inputted map element. From there processing proceeds to block 1560 where I/RN benchmarking data is identified for which to associate to the newly inputted map element. Processing proceeds to block 1545 and continues from there. Processing then terminates at block 1565.

FIG. 16 shows an illustrative graphical representation of an exemplary I/RN map 1600 for an exemplary participating user. As is shown, I/RN map 1600 comprises a central graphical representation of a user, 1601, of the I/RN system, shown as user avatar 1602. As shown, user avatar 1602 might display a photo or other graphical representation of user 1601. Although not shown in FIG. 16, user avatar 1602 might also include a display of one or more data types relating to user 1601, for example, name, birthdate, age, etc. As shown in FIG. 16, user avatar 1602 is surrounded by a graphical representation 1606 of the various categories of top-level resource networks 1604 (e.g., family, professional, household) of user 1601. As shown in FIG. 16, in a preferred embodiment, graphical representation 1606 of the user's top-level resource networks is a circular graphic surrounding the user avatar 1602. Although shown in FIG. 16 as including 5 top-level resource networks 1604a-1604e (e.g., circular network representation segments 1608a-1608e, each corresponding, respectively, to top-level resource networks 1604a-1604e), any number of top-level resource networks and corresponding circular network representations might be displayed in network representation 1606, for example depending on the number of top-level resource networks 1604 user 1601 has in the I/RN system. Although shown in FIG. 16 as each circular network representation segment 1608a-1608e being sized corresponding to the length of the text name of each top-level resource network 1604, in other embodiments, each circular network representation segment 1608a-1608e is sized corresponding to the number of sub-categories 1610 in each top-level resource network 1604. For example, in such embodiments the education/enrichment resource network (e.g., circular network representation segment 1608a corresponding to resource network 1604a) would have a smaller graphical size on the circle surrounding the user avatar 1602 than would medical resource network (e.g., circular network representation segment 1608e corresponding to resource network 1604e), indicating that medical resource network 1604e has a greater number of sub-categories (3) 1610 than does education/enrichment resource network 1604a (2).

As shown in FIG. 16, user 1601 might have 5 top-level resource networks (e.g., top-level resource networks 1604a-1604e), for example, education/enrichment resource network 1604a, spiritual resource network 1604b, social network 1604c, family network 1604d, and medical network 1604e. Further, each top-level resource network might be assigned a unique color code such that each top-level resource network can be easily visually identified. In a preferred embodiment, the unique color code for each top-level resource network is displayed on each circular network representation segment 1608, each unique, non-overlapping network sub-category container 1612, and each connecting line 1616 between the containers 1612 and the user avatar 1602. For example, in the embodiment of FIG. 16, education/enrichment resource network 1604a could be assigned a green color code, spiritual resource network 1604b could be assigned a purple color code, social network 1604c could be assigned a red color code, family network 1604d could be assigned a blue color code, and medical network 1604e could be assigned an orange color code. Similarly, each circular network representation segment 1608a-1608e, each unique, non-overlapping network sub-category container 1612, and each connecting line 1616 could also displayed having the same color code. In alternate embodiments, it should be understood that any unique combinations of colors could be employed such that each top-level category has its own, unique, color code. For example, user 1601 might be able to select the color of each top-level resource network, or the I/RN system might automatically assign the color for each top-level resource, or a combination thereof.

In one embodiment, such as shown in FIG. 16, each sub-category 1610 might be represented by a unique, non-overlapping network sub-category container (shown as 1612) containing one or more entries (shown as entries 1614). As described herein, each top-level resource network might typically correspond to high level I/RN relationships separated based on the type of relationship (e.g., family, professional, social, charitable, clubs, educational, religious, experience, etc.). Each sub-category might typically correspond to a type of resource or connection, or a further sub-category within a given sub-category. For example, the sub-categories might represent functional or structural units within each top-level network. For example, top-level category 1604d for family is shown to include sub-categories 1610a-1610d, where sub-category 1610a corresponds to the immediate family, sub-category 1610b corresponds to the grandparents, sub-category 1610b corresponds to the cousins, and sub-category 1610d corresponds to the aunts and uncles. Within each sub-category 1610 are one or more entries 1614 that correspond to specific activities, operations, and/or individuals who are within the sub-category. For example, sub-category 1610b corresponds to the grandparents of user 1601 and includes entries 1614a-1614e, each corresponding to an individual who is a grandparent (or great-grandparent) of user 1601.

Although not shown as such in FIG. 16 for the sake of simplicity, any of entries 1614 might be a sub-category 1608 having a corresponding, unique, non-overlapping container 1612 of entries 1614, to form a multiple-branch tree hierarchy. For example, for sub-category 1610b corresponding to the grandparents of user 1601, an entry might be a sub-category for maternal grandparents, and another entry might be a sub-category for paternal grandparents. Within those sub-categories might be entries that are sub-categories for great-grandparents, and so on. Alternative embodiments might include only one-level of hierarchy, where entries 1614 cannot be sub-categories, to help user 1601 maintain a simple organization of their resources. Yet other embodiments might include data for any number of subcategory hierarchies (e.g., a user-selectable number of sub-categories, or an automatically defined number of categories based on input user data) while presenting the I/RN map for viewing having user-collapsible hierarchies such that some views of the I/RN data display a simple hierarchy, while other views might display additional, more detailed levels of sub-categories.

Further, although shown in FIG. 16 as being circles, unique, non-overlapping network sub-category containers 1612 might be represented in any non-overlapping shape. In some embodiments, all sub-category containers 1612 might be the same shape, such as the circles shown in FIG. 16, although any other shape (e.g., squares, rectangles, trapezoids, triangles, etc.) could be employed. In other embodiments, the containers 1612 might be each assigned a unique shape to help user 1601 visually differentiate various different types of containers within a given color code. For example, user 1601 might be able to select the shape of each container individually, might be able to select the shape of containers within each given top-level resource network 1604, or might be able to select the shape of given types of sub-category containers 1608. Alternatively, the I/RN system might automatically assign the shape for each top-level category, each individual category, each type of sub-category container, or a combination thereof.

Although typically the various top-level resource network categories 1604, sub-categories 1608 and entries 1614 might be labeled, organized and populated with data based on data input by user 1601, in some embodiments, the I/RN system might suggest new top-level categories, sub-categories, and/or entries for user 1601. For example, suggestions might be dynamically generated by the I/RN system based on data input by user 1601. For example, if user 1601 is a military veteran, the I/RN system might automatically suggest adding a top-level resource network 1604 for military contacts and resources. Further, the I/RN system might automatically suggest adding one or more sub-categories 1608, for example based on individual military branches or individual units, veterans organizations, veterans charities and other resources for active duty or retired military personnel. Even further, the I/RN system might automatically suggest adding individual entries 1614, for example to add individuals who served in the same military unit, to add individuals who were stationed in the same region in the same time frame, etc.

As described herein, users answer a set of questions, and the I/RN system then generates their map automatically with pre-designed “normative” templates of relationships mapping major relationship domains (e.g., the top-level categories described in regard to FIG. 16). Moreover, based on the input user data, the I/RN system might dynamically and automatically suggest sponsored categories and/or advertisements. For example, as described in regard to FIG. 8, if user 1601 enters data indicating a life change event (e.g., changing jobs, graduating school, getting married, starting a family, etc.), the I/RN system might present one or more sponsored category suggestions and/or advertisements for suggested service providers or sellers. For example, if user 1601 becomes pregnant, the I/RN system might automatically suggest that the user add various top-level categories, sub-categories or individual entries to their I/RN map that logically related to a pregnancy, such as suggesting adding a top-level category for medical personnel and a top-level category for child care personnel. In described embodiments, the user can select those suggested top-level categories that the user desires to add to their map, at which point the I/RN system might suggest one or more related sub-categories for each added top-level category, for example, suggesting primary care, obstetrical, and pediatric sub-categories for the medical top-level category, and suggesting baby sitter and nanny sub-categories for the child care top-level category. Again, the user can select those suggested top-level categories that the user desires to add to their map, at which point the I/RN system might suggest one or more related individual entries to be added to the map. These individual entry suggestions might be based on network information of the user, for example by suggesting a baby sitter that might already be known to the user as determined based on input user data. Alternatively or additionally, the individual entry suggestions might be sponsored advertisements for nearby providers within the top-level category and/or sub-category. Further, the suggestions might relate to charitable, educational or other resources that might be relevant, as in the exemplary case of a pregnancy, these suggestions might include such resources as parenting classes, Lamaze classes, and other resources that might benefit a new parent.

In particular, in the prior art, there are no robust tools to help parents understand or manage children's networks. Children's networks are largely ignored, even in parenting literature and classes. Each new child adds an exponential number of teachers, coaches, friends and friends' parents to the network management tasks that parents face. If a child becomes seriously ill or has a special need—or special talent—the numbers grow larger still. Thus, the described embodiments can help parents visualize, understand and better manage their children's networks, in the exemplary top-level categories shown in FIG. 16: immediate and extended family, social resources, health and medical care, education and enrichment, and spirituality. These described embodiments can help parents understand their children's' networks, enable friends and family to provide useful, unique and targeted gifts as an individual's network changes, and can enable professionals, service providers and others to target their offerings to the individuals most likely to be interested in using their goods and services.

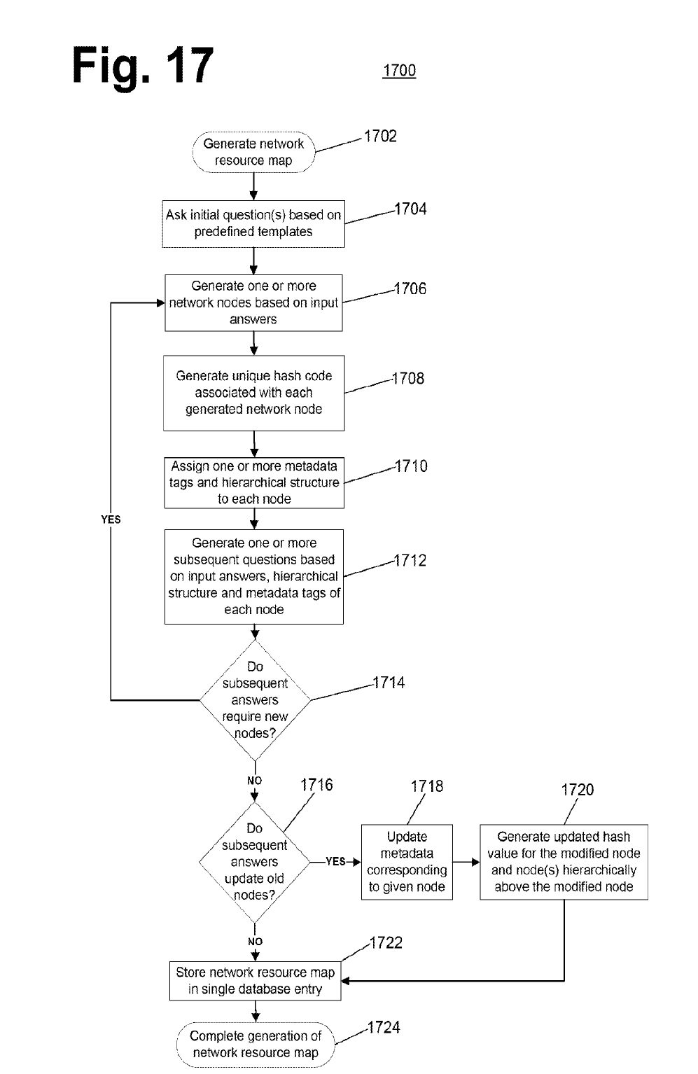

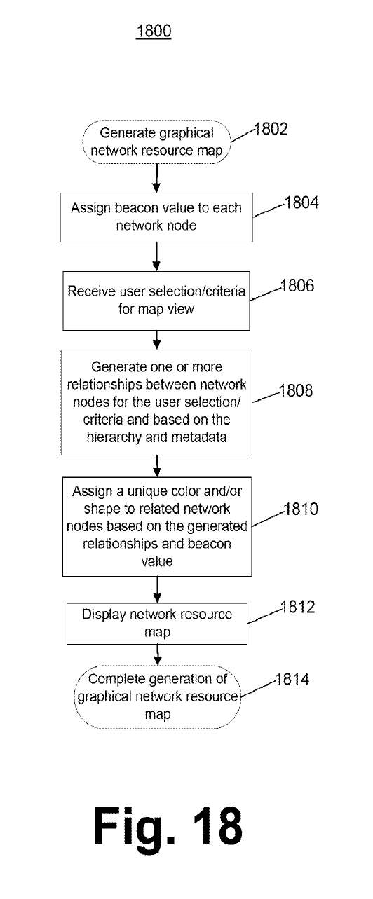

FIG. 17 shows a flow diagram of process 1700 for generating a network resource map of a user in accordance with exemplary embodiments. At step 1702, process 1700 begins. At step 1704, initial questions or data prompts are presented to the user based upon predefined templates. For example, initial questions about the user his or her self might be asked (e.g., name, gender, age, birthdate, height, weight, information about their parents, etc.). At step 1706, one or more network nodes are created by the I/RN system in response to the user's responses. For example, an initial network node for the user and any other entities is generated.

At step 1708, the network nodes generated at step 1706 are assigned a unique hash code based on the initial data associated with the node and the time of creation of the node. For example, described embodiments might employ a pseudo-random number generator to perform a hash function in accordance with the Secure Hash Algorithm (SHA) as defined by the U.S. Federal Information Processing Standard (FIPS) Publications 180, 180-1, and 180-2, published by the National Institute of Standards and Technology (NIST). At step 1710, one or more metadata tags are generated for each network node based on the initial data associated with the given node and the hierarchical level of the node. At step 1712, one or more subsequent questions or data prompts are generated and presented to the user based upon the previously input responses, the hierarchical structure of the network resource map and the metadata tags associated with each node. For example, if the user's initially input data indicates the user is of a certain age, a subsequent question might be presented to ask about things typically associated with that age (e.g., a child might be presented with questions about school, an adult might be presented questions about a job, spouse or children, etc.). Thus, each answer entered by the user can result in a new question being asked (or certain questions NOT being asked). Therefore, described embodiments employ a so-called “jagged array” to store the resource map data. A jagged array is an array whose individual constituent elements are arrays. Thus, the elements of a jagged array can be of different dimensions and sizes that are dynamically determined during the creation and subsequent modification of the network resource map. Thus, each node can have up to N unique metadata tags associated with it, since the corresponding element in the jagged array can be made of any size needed in real-time. Further, at step 1714, if the user's answers to subsequent questions or data prompts require new network nodes, process 1700 returns to step 1706 to generate any required network nodes and again refine what subsequent questions and data prompts are presented to the user.

If, at step 1714, no new network nodes are needed, at step 1716, the user's answers to subsequent questions or data prompts requires updates to previously generated network nodes, process 1700 proceeds to step 1718, where the metadata of the corresponding node(s) is updated based on the user's answers. At step 1720, because the data of a network node has been updated, the I/RN system generates an updated hash value for the modified network node, and also for any network nodes that are hierarchically located above the modified network node (e.g., if a child node is modified, the child node and its corresponding parent node both are given new hash values). Process 1700 proceeds to step 1722. If, at step 1716 no updates were required for existing network nodes, process 1700 proceeds to step 1722. At step 1722, the entire network resource map (e.g., the metadata, hash values, and hierarchical relationships for every network node) is stored in a single database entry. Thus, regardless of the number of nodes contained within a network resource map, it is always stored within the a single database entry. However, each time any portion of the network resource map is modified, the network resource map is saved in a separate, unique single database entry. Thus, the user can see how their network resource map has changed over time by viewing past versions of the map. At step 1724, process 1700 completes.

Although not shown in FIG. 17, multiple network nodes might contain similar metadata tags, but be differentiated by other metadata tags and/or the hierarchical level of each node. For example, if the user is a parent, their child might have a metadata tag “Son” or “Daughter”, but the user him or her self could also have a metadata tag “Son” or “Daughter” if information is added to the resource network related to the user's parents, but the user and their child would have different hierarchical levels, and likely numerous other differentiable metatags. Similarly, multiple individuals might share a common name, location, school, or other metadata tags, but they can be searched and differentiated based on other metadata tags and/or the hierarchical level of each node. In some embodiments, the metadata tags and hierarchical level might be used to generate a score or beacon value for each node. In turn this score or beacon value might be used by the I/RN system to determine, for example, the assigned color code or shape for a given network node.

FIG. 18 shows a flow diagram of process 1800 for generating the graphical output for the network resource map. At step 1802, the graphic map generation begins. At step 1804, a beacon value is assigned to each network node. For example, the metadata tags and hierarchical level might be used to generate a score or beacon value for each node. In turn this score or beacon value might be used by the I/RN system to determine, for example, the assigned color code or shape for a given network node. At step 1806 the user selects one or more criteria or search terms to generate the graphical network map. For example, the user might select to view only a portion of their network (e.g., personal associations), and further narrow the results or look for any relationships based on financial wealth, like interests, sports or physical activities, duration of existence of the relationship, etc. At step 1808, the I/RN system determines relationships between the various network nodes based on the user's selected criteria, the metadata associated with each various network node, the hierarchy level of each various network node and/or the beacon value. At step 1810, the I/RN system assigns at least one of a unique color code and a unique shape to related network nodes, such as described in regard to FIG. 16. At step 1812, the I/RN system displays the generated user map to the user, for example on a computer screen. The I/RN system only displays network nodes that match the appropriate hierarchy and metadata based on the user's criteria.

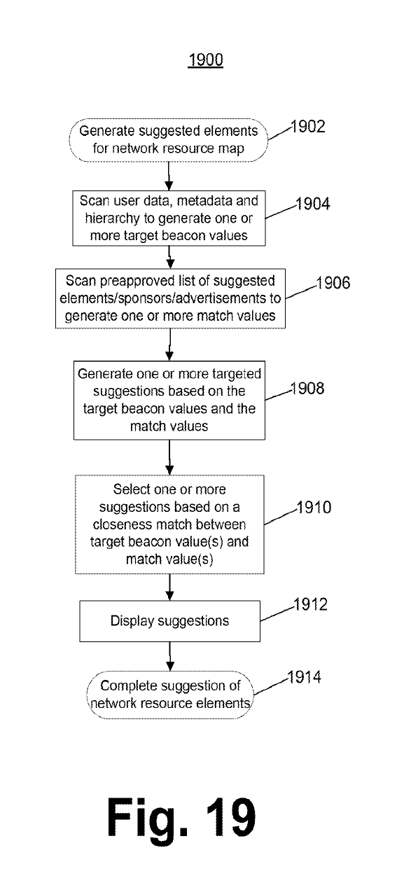

FIG. 19 shows a flow diagram of process 1900 for generating suggested network elements for the user. As described herein in regard to FIG. 16, based on the input user data, the I/RN system might dynamically and automatically suggest sponsored categories and/or advertisements. For example, as described in regard to FIG. 16, if user 1601 enters data indicating a life change event (e.g., changing jobs, graduating school, getting married, starting a family, etc.), the I/RN system might present one or more sponsored category suggestions and/or advertisements for suggested service providers or sellers. As shown in FIG. 19, at step 1902, process 1900 begins. At step 1904, the entered user data, assigned metadata tags and hierarchy levels for each network node are scanned to generate one or more target beacon values. At step 1906, a preapproved list of certified advertisements, vendors, providers, sponsors, etc., is scanned to generate match values for comparison, at step 1908, with the target beacon values. At step 1910, one or more suggested network elements are selected by the I/RN system based on how close the target beacon value matches the match values of each element of the preapproved list. For example, if a target beacon value is within a given range tolerance of the match values for one or more elements of the preapproved list, the corresponding element of the preapproved list is selected by the I/RN system as a suggested network element. At step 1912, the suggestion(s) selected are displayed to the user. Process 1900 completes at step 1914.

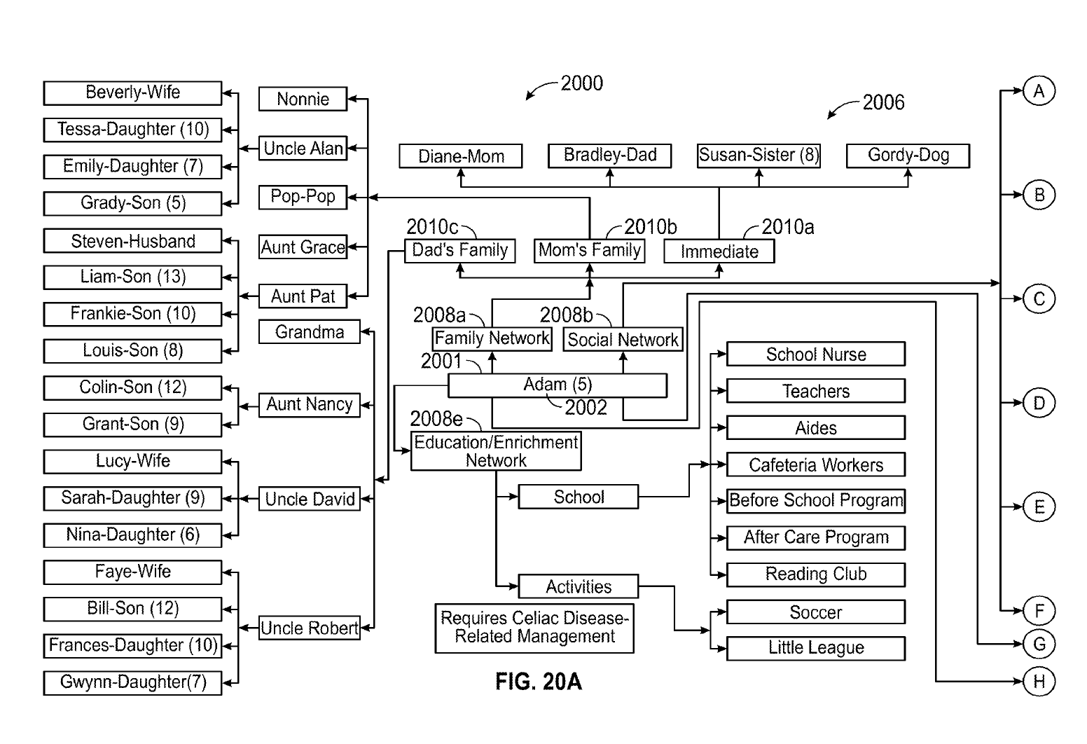

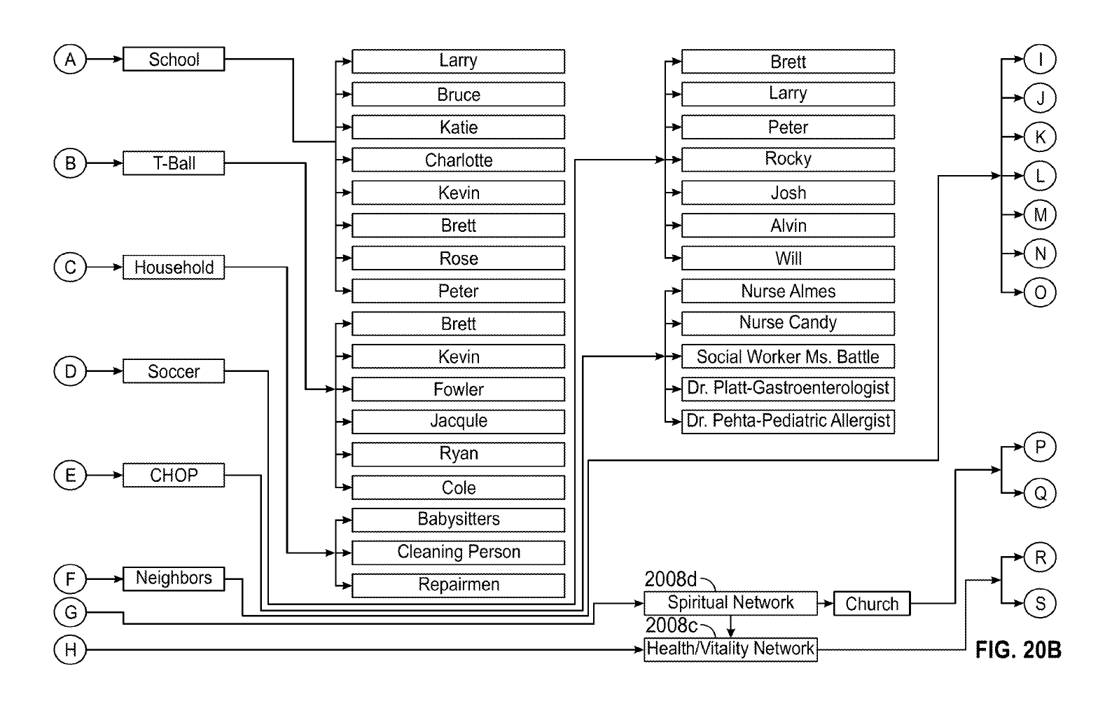

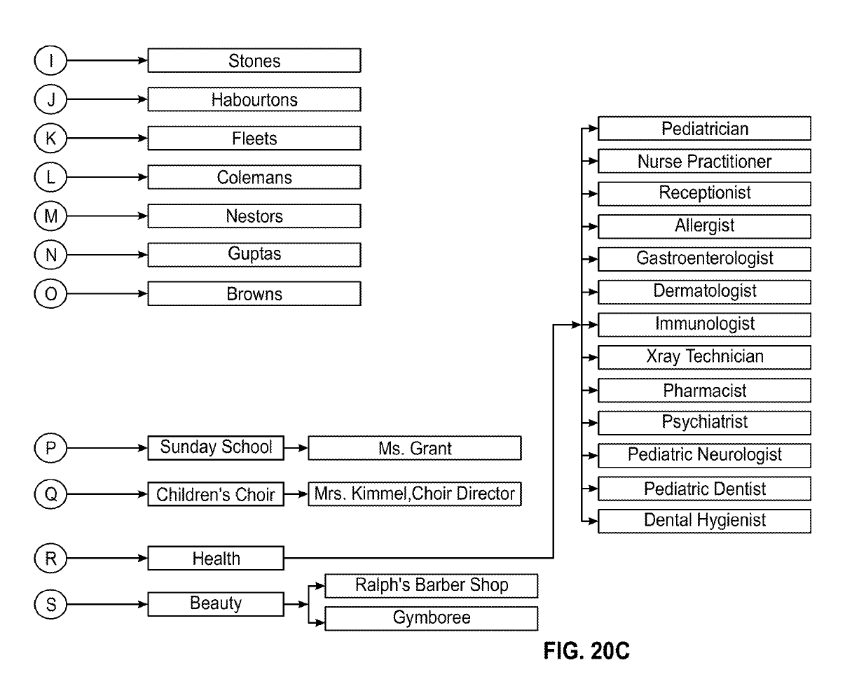

The systems and methods according to the present invention can, in some embodiments, be employed to manage the network of an individual who suffers from a particular disease or condition. In many cases a disease or condition presents unique challenges that require specialized management of an individual's network. FIG. 20 shows an illustrative graphical representation of an exemplary I/RN map 2000 for an exemplary participating user, who in this embodiment is a five year old boy named Adam that has Celiac Disease. Individuals with Celiac Disease must carefully control their diets to avoid foods containing gluten, which is a protein composite found in wheat, barley, and rye. Thus, in this embodiment, the I/RN map 2000 is used to illustrate Adam's network in a network representation 2006 so that the relevant individuals can be identified and those individuals educated about Adam's disease and the measures necessary to manage his disease. In this embodiment, I/RN map 2000 comprises a central graphical representation of a user information block 2001 containing the user's name and age 2002. As shown in FIG. 20, the user information block 2001 is surrounded by a graphical “tree”-like representation of the user's network, including in this embodiment five major branches that each represents one of the user's top-level resource networks 2008a-2008e, i.e., family network 2008a, social network 2008b, health/vitality network 2008c, spiritual network 2008d, and education/enrichment network 2008e. It should be understood that any number of top-level resource networks and corresponding major branches might be displayed in network representation 2006, for example depending on the number of top-level networks that user has has in the I/RN system 2000. Each top-level resource network 2008a-2008e may be further divided into separate network subcategories, which are represented in the network representation 2006 of FIG. 20 as smaller branches extending from one of the major branches. For example, the family network 2008a in this embodiment is divided into three separate intermediate-level resource networks branches for immediate family 2010a, the user's mom's family 2010b, and the user's dad's family 2010c. These network subcategories may be subdivided further into bottom-level resource networks and/or until individuals or individual entities are identified on minor branches of the network representation 2006.

Once the user's I/RN map 2000 has been constructed, the various top-level resource networks 2008a-2008e, intermediate-level resource networks 2010a-2010c, low-level resource networks and/or individuals or individual entities within the user's network may be individually or collectively indicated as requiring specialized management for the end purpose of effectively managing the user's disease or condition. As shown in FIG. 20, in this network representation 2006 all of the various resource network branches are shaded a single color (e.g., green) to indicate that each relationship within the user's I/RN map 2000 requires active management because, in the case of Celiac Disease, the user could be exposed to gluten-containing foods or products via any one of these relationships. In alternate embodiments, particular resource networks or individual relationships within the user's I/RN map 2000 need not be identified as requiring active management, and therefore the respective branches within the network representation 2006 thereof could be coded with some different color (e.g., gray) that distinguishes it from the color used for those branches that require active management on the network representation 2006. Any unique color(s) could be used to indicate relationships that require and do not require active management within the network representation 2006.

In some embodiments, certain relationships within a user's I/RN map 2000 may require special or additional efforts to ensure that that relationship is effectively managed. For example, in the case of a user with Celiac Disease, certain individuals within the user's I/RN map 2000 may be particularly ignorant about the nature of the Disease or lack diligence in helping to control the user's diet, or may even be skeptical about the very existence of the Disease. These relationships requiring special or additional management efforts are referred to in this context as “high touch” relationships, and may be specially color coded or otherwise marked in the network representation 2006 of the user's I/RN map 2000 to call attention to these relationships.

In cases where additional individuals desire or need to be actively involved in managing a user's I/RN map 2000, for example in the case of five year old Adam shown in FIG. 20 whose I/RN map 2000 is primarily managed by his mother and father, information about the user's I/RN map 2000 may be tabulated to show the total number of relationships that must be managed by each of the additional individuals, and this data may be categorized further into regular and “high touch” relationships managed by each additional individual.

Table 2 shows a breakdown of the number of individual relationships within Adam's top-level resource networks 2008a-2008e, which serves as a tool to permit Adam's mother and father to fully appreciate the number of individuals that they are responsible for contacting about Adam's disease and the number of “high touch” individuals that must be actively managed by each:

TABLE 2

| | | | Number of | Number of |
|---|---|---|---|---|
| | Number of | Number of | “High Touch” | “High Touch” |
| Adam's | People Mom | People Dad | People Mom | People Dad |
| Networks | Contacted | Contacted | Managed | Managed |
| Family | 29 | | 3 | |
| Network | | | | |
| Health/ | 19 | | 4 | |
| Vitality | | | | |
| Education/ | | 51 | | 5 |
| Enrich- | | | | |
| ment | | | | |
| Spiritual | | 2 | | |
| Social | | 47 | | 7 |
| Total | 48 | 100 | 7 | 12 |

Thus, described embodiments can provide I/RN maps that are self-tailoring for different life situations, different career situations and address the number of relationships, the degree of closeness or intimacy with others, how and why the user engages with their network, how the users impact their network and how that network impact them, for example by differentiating between primary (that is, the most important) relationships and the people who fill “support” functions as well (e.g., a parent would be a “primary” relationship, while a teacher or sports coach would be “supporting” the parent's intention that the child be educated and coached). These “supports” occupy an important place in the entire relationship network landscape providing a variety of services, many of which are essential for health, education, career success, happiness and well-being, but they are rarely fully considered or even held accountable for the support they provide, including when users pay for what they receive. Mapping tools encourage users to review the quality of the support services they receive from others in their networks. Further, described embodiments might categorize and track a variety of “transactional” relationships (e.g., dry cleaners, stores, restaurants) that users interact with on a routine basis for provision of goods or services.

It is understood that the herein described systems and methods are susceptible to various modifications and alternative constructions. There is no intention to limit the herein described systems and methods to the specific constructions described herein. On the contrary, the herein described systems and methods are intended to cover all modifications, alternative constructions, and equivalents falling within the scope and spirit of the herein described systems and methods.

It should also be noted that the herein described systems and methods can be implemented in a variety of electronic environments (including both non-wireless and wireless computer environments and including cell phones and video phones), partial computing environments, and real world environments. The various techniques described herein may be implemented in hardware or software, or a combination of both. Preferably, the techniques are implemented in computing environments maintaining programmable computers that include a computer network, processor, servers, a storage medium readable by the processor (including volatile and non-volatile (e.g., non-transitory) memory and/or storage elements), at least one input device, and at least one output device. Computing hardware logic cooperating with various instructions sets are applied to data to perform the functions described above and to generate output information. The output information is applied to one or more output devices. Programs used by the exemplary computing hardware may be preferably implemented in various programming languages, including high level procedural or object oriented programming language to communicate with a computer system. Illustratively the herein described apparatus and methods may be implemented in assembly or machine language, if desired. In any case, the language may be a compiled or interpreted language. Each such computer program is preferably stored on a non-transitory storage medium or device (e.g., ROM or magnetic disk) that is readable by a general or special purpose programmable computer for configuring and operating the computer when the storage medium or device is read by the computer to perform the procedures described above. The apparatus may also be considered to be implemented as a computer-readable storage medium, configured with a computer program, where the storage medium so configured causes a computer to operate in a specific and predefined manner.

While the exemplary embodiments have been described with respect to software processes, described embodiments are not so limited. Such software might be employed in, for example, a digital signal processor, microcontroller, or general-purpose computer. Such software might be embodied in the form of program code embodied in tangible media, such as magnetic recording media, optical recording media, solid state memory, floppy diskettes, CD-ROMs, hard drives, or any other non-transitory machine-readable storage medium, wherein, when the program code is loaded into and executed by a machine, such as a computer, the machine becomes an apparatus for practicing the described embodiments. When implemented on a general-purpose processor, the program code segments combine with the processor to provide a unique device that operates analogously to specific logic circuits. The described embodiments can also be embodied in the form of a bitstream or other sequence of signal values electrically or optically transmitted through a medium, stored magnetic-field variations in a magnetic recording medium, etc., generated using a method and/or an apparatus of the described embodiments.

As would be apparent to one skilled in the art, various functions of software might also be implemented as processes of circuits, including possible implementation as a single integrated circuit, a multi-chip module, a single card, or a multi-card circuit pack.

It should be understood that the steps of the exemplary methods set forth herein are not necessarily required to be performed in the order described, and the order of the steps of such methods should be understood to be merely exemplary. Likewise, additional steps might be included in such methods, and certain steps might be omitted or combined, in methods consistent with various embodiments.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

Unless explicitly stated otherwise, each numerical value and range should be interpreted as being approximate as if the word “about” or “approximately” preceded the value of the value or range. Signals and corresponding nodes or ports might be referred to by the same name and are interchangeable for purposes here.

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements. Signals and corresponding nodes or ports might be referred to by the same name and are interchangeable for purposes here.

Although exemplary implementations of the herein described systems and methods have been described in detail above, those skilled in the art will readily appreciate that many additional modifications are possible in the exemplary embodiments without materially departing from the novel teachings and advantages of the herein described systems and methods. Accordingly, these and all such modifications are intended to be included within the scope of the herein described systems and methods. The herein described systems and methods may be better defined by the following claims.

We claim:

1. A method of generating a network resource map of a user, the method carried out by a system comprising at least one computing device coupled to at least one non-transitory computer-readable medium, the method comprising:
receiving data inputted by the user as received data, the received data indicative of at least one of a relationship, resource, and life event of the user;
generating, based on the received data: (i) a hierarchical tree comprising a plurality of nodes, each node corresponding to all or a portion of the received data, (ii) one or more metadata tags for each node; and (iii) for each node, an original hash value of the metadata for the node;
generating, based on the one or more metadata tags for each node, hierarchical associations between the various nodes;
generating and displaying, based on the generated hierarchical associations and at least one user preference, the network resource map of the user; and
storing, in a first single database entry, the network resource map of the user.

2-6. (canceled)

7. The method of claim 1, wherein the nodes comprise one or more interaction/resource top-level categories, one or more sub-categories, and one or more entries.

8. The method of claim 7, wherein each top-level category has at least one sub-category, and each sub-category has at least one entry.

9. The method of claim 8, wherein the at least one entry comprises a sub-category.

10. The method of claim 7, wherein each top-level category and its corresponding one or more sub-categories are assigned a unique color code.

11. (canceled)

12. The method of claim 7, wherein each top-level category and its corresponding one or more sub-categories are assigned a unique shape.

13-29. (canceled)

30. A method for aggregating and managing data, comprising:
(a) receiving data representative of a plurality of interaction/resource network elements, each of the interaction/resource network elements comprising a relationship or resource;
(b) selecting at least one interaction/resource network data type based on at least one characteristic of one of the plurality of received interaction/resource network elements and associating the at least one interaction/resource network data type with one of the plurality of received interaction/resource network elements; and
(c) generating at least one interaction/resource network contextual data association, each of the at least one interaction/resource network contextual data associations defining an association between at least two of the plurality of interaction/resource network elements based on at least one characteristic of each of the at least two of the plurality of interaction/resource network elements;
(d) generating a graphical representation that shows the plurality of interaction/resource network elements, the at least one interaction/resource network contextual data association and the at least one characteristics of the plurality of interaction/resource network elements for which an association is defined in step (c).

31. The method as recited in claim 30, further comprising:
(e) retrieving data representative of interaction/resource network referral data from one or more cooperating data stores based on the at least one interaction/resource network data type selected in step (b); and
(f) communicating the generated graphical representation and interaction/resource network referral data to one or more cooperating computing environments.

32. The method as recited in claim 30, wherein the graphical representation comprises an interaction/resource network element map.

33-34. (canceled)

35. The method as recited in claim 30, wherein each of the at least one characteristic of each of the at least two of the plurality of interaction/resource network elements comprises data representative of a degree of separation between each of the at least two of the plurality of interaction/resource network elements along a tree of consanguinity, data representative of placement of one of the plurality of interaction/resource network elements on a selected organizational chart, data representative of a type of relationship or resource represented by one of the of plurality of interaction/resource network elements, data representative of an age of a relationship represented by one of the plurality of interaction/resource network elements, or data representative of a demographic of one of the plurality of interaction/resource network elements, the demographic comprising age data, gender data, income data, location data, education data, and/or career data.

36. The method as recited in claim 30, further comprising:
(g) retrieving at least one interaction scenario from one or more cooperating data stores based on the at least one interaction/resource network contextual association generated in step (c), each of the at least one interaction scenario comprising at least one interaction/resource network data type; and
(h) including each of the at least one interaction/resource network data type in the graphical representation generated in step (d).

37. The method as recited in claim 30, wherein each of the at least one interaction/resource network element received in step (a) is received from one or more computing environments operable to execute an interactive graphical user interface (IGUI) that is operable to interactively input an interaction/resource network element.

38. The method as recited in claim 30, wherein the interaction/resource network data types comprises data representative of one or more categories of relationships comprising present, past, and/or future personal relationships, professional relationships, relationships with pets, relationships with objects, spiritual relationships, and social relationships.

39. The method as recited in claim 31, wherein the interaction/resource network referral data retrieved in step (e) comprises data representative of content regarding management of one or more relationships, content regarding management of one or more relationship types, or content regarding one or more professional service providers.

40. The method as recited in claim 31, wherein the at least one interaction/resource network contextual association comprises data representative of a degree of separation between the at least two of the plurality of interactions/resource network elements.

41. The method as recited in claim 30, further comprising generating contextual interaction/resource network data comprising data representative of the degree of separation between one or more interactions/resource network elements.

42. The system as recited in claim 30, wherein step (a) comprising receiving data representative of a plurality of interaction/resource network elements, each of the interaction/resource network elements comprising a past, present or future personal relationship, professional relationship, relationships with a pet, relationship with an object, spiritual relationship, or social relationship.
